(19) United States
(12) Patent Application Publication
(10) Pub. No.: US 2020/0071502 A1
(43) Pub. Date: Mar. 5, 2020

(54) RESIN COMPOSITION AND RESIN MOLDED ARTICLE

(71) Applicant: FUJI XEROX CO., LTD., Tokyo (JP)

(72) Inventors: Kana MIYAZAKI, Minamiashigara-shi (JP); Ryo TANAKA, Minamiashigara-shi (JP); Kenji YAO, Minamiashigara-shi (JP)

(73) Assignee: FUJI XEROX CO., LTD., Tokyo (JP)

(21) Appl. No.: 16/269,131

(22) Filed: Feb. 6, 2019

(30) Foreign Application Priority Data
Aug. 31, 2018 (JP) 2018-164062

(51) Int. Cl. C08L 1/14; C08L 67/04; C08K 5/00; B29C 45/00

(52) U.S. Cl. CPC C08L 1/14; C08L 67/04; B29K 2001/14; B29C 45/0001; C08K 5/0016

(57) ABSTRACT

A resin composition includes a resin (A) having a biomass-derived carbon atom, in which a ratio (E′f80/E″f80) of a storage modulus E′f80 to a loss modulus E″f80 at a frequency of 1 Hz and at a temperature of 80° C. is from 5 to 15 in a dynamic viscoelasticity measurement defined in JIS K7244-3:1999.

### CROSS-REFERENCE TO RELATED APPLICATIONS

This application is based on and claims a priority under 35 USC 119 from Japanese Patent Application No. 2018-164062 filed on Aug. 31, 2018.

### BACKGROUND

### Technical Field

The present invention relates to a resin composition and a resin molded article.

### Related Art

In the related art, various resin compositions have been provided and used for various purposes. The resin compositions have been particularly used for household electric appliances and various parts of automobiles, housings, and the like. In addition, thermoplastic resins have been also used for parts such as office equipment and housings of electronic and electrical equipment.

In recent years, a plant-derived resin has been used, and as one of the plant-derived resins known in the related art, a resin having a biomass-derived carbon atom such as cellulose acylate may be exemplified.

For example, JP-A-2016-23273 discloses “a resin composition contains at least one compound selected from an aromatic polyester resin, a polylactic acid resin, a carbodiimide compound, an epoxy compound, an oxazoline compound, an oxazine compound, and an aziridine compound, in which a tan δ peak obtained by viscoelasticity measurement indicates a single peak in a range from 60° C. to 90° C.

### SUMMARY

Meanwhile, when a resin molded article is molded from a resin composition, a step of applying a pressure (so-called holding pressure) is performed to compensate for volume shrinkage when a molten resin is cooled and hardened. In a case where the pressure at the time of holding pressure is low, sink marks are generated; whereas in a case where the pressure is high, residual stress is generated and deformation is induced in some cases. For this reason, it has been required to obtain a resin molded article which prevents such sink marks and transformation and has high dimensional accuracy.

Aspects of certain non-limiting embodiments of the present disclosure relate to a resin composition containing a resin (A) having a biomass-derived carbon atom, which is capable of obtaining a resin molded article with high dimensional accuracy as compared with a case where a ratio (E′f80/E″f80) of storage modulus E′f80 to loss modulus E″f80 at a frequency of 1 Hz and at a temperature of 80° C. is less than 5 or larger than 15.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a resin composition containing: a resin (A) having a biomass-derived carbon atom, in which a ratio (E′f80/E″f80) of a storage modulus E′f80 to a loss modulus E″f80 at a frequency of 1 Hz and at a temperature of 80° C. is from 5 to 15, in a dynamic viscoelasticity measurement defined in JIS K7244-3:1999.

### DETAILED DESCRIPTION

Hereinafter, an exemplary embodiment which is an example of the present invention will be described.

In this specification, in a case where there are plural kinds of substances corresponding to each component in a subject, unless otherwise specified, the amount of each component in the subject means a content rate or a content of a total amount of the plural kinds of substances in the subject.

In addition, the expression “polymer of X” is an expression including a copolymer of X and a monomer other than X, in addition to a homopolymer of X only. Similarly, the expression “copolymer of X and Y” is an expression including a copolymer of X, Y, and a monomer other than X and Y, in addition to a copolymer of X and Y only (hereinafter, also referred to as “single copolymer” for convenience).

In addition, resin (A) having a biomass-derived carbon atom, plasticizer (B), and compound (C) are also referred to as component (A), component (B), and component (C), respectively.

<Resin Composition>

The resin composition according to the exemplary embodiment contains a resin (A) having a biomass-derived carbon atom (hereinafter, simply referred to as “bioresin (A)” as well).

In the dynamic viscoelasticity measurement defined in JIS K7244-3:1999, the ratio (E′f80/E″f80) of storage modulus E′f80 to loss modulus E″f80 at the frequency of 1 Hz and at the temperature of 80° C. is from 5 to 15.

Generally, in a case where a resin molded article is molded by melting a resin composition to mold and then solidify the molten resin composition (for example, injection molding or the like), a step of applying a pressure (so-called holding pressure) is performed in order to compensate for the volume shrinkage when the molten resin is cooled and solidified. In a case where the pressure at the time of holding pressure is low, sink marks, that is, depressions due to molding shrinkage are generated. On the other hand, in a case where the pressure is high, residual stress is generated, and thus deformation of the resin molded article is induced.

In contrast, according to the resin composition according to the exemplary embodiment having the above configuration, there is provided a resin composition which is capable of obtaining a resin molded article with high dimensional accuracy.

The reason for this is inferred as follows.

When the molten resin composition is molded (for example, flows into a mold) and further cooled, a temperature gradient is generated from the center to a surface of the molded resin composition, and the fluidity is low on the surface side as compared with that at the center. When the holding pressure is applied in this state, the center side of the molded resin composition is filled with a resin, and the surface being solidified is stretched. At this time, when the elasticity of the resin composition is excessively high, stretching on the surface side, that is, in a stretched region is unlikely to occur, and high holding pressure is required in order to eliminate sink marks, and thus excessive residual stress of the molded article is generated and deformation is likely to occur. On the contrary, if the viscosity of the resin composition is excessively high, the surface is not sufficiently solidified, so that the resin is likely to leak out of the mold without eliminate sink marks in the holding pressure step, and burr is likely to occur.

Here, the ratio (E′f80/E″f80) of storage modulus E′f80 to loss modulus E″f80 at a temperature of 80° C. is an indicator indicating that as the ratio is larger, the elasticity is strong; whereas the ratio is small, the viscosity is strong. That is, setting the ratio (E′f80/E″f80) in the resin composition according to the exemplary embodiment to be within the above range means that the viscosity and the elasticity are within an appropriate range at a temperature of 80° C. at which solidification from a glass state in the resin is coming to completion.

For this reason, it is considered that when the molded resin composition is cooled and solidified, the stretching on the surface side is favorably performed to prevent the sink marks from being generated while the residual stress is prevented from occurring to make deformation hardly occur.

As described above, in the exemplary embodiment, it is presumed that there is provided a resin composition which is capable of obtaining high dimensional accuracy when forming a resin molded article.

Ratio (E′f80/E″f80) at Temperature of 80° C.

The ratio (E′f80/E″f80) of storage modulus E′f80 to loss modulus E″f80 at the frequency of 1 Hz and at the temperature of 80° C. is from 5 to 15, is preferably from 6.5 to 13, and is more preferably from 7 to 11.

When the ratio (E′f80/E″f80) at the temperature of 80° C. is 5 or more, the resin composition has moderate elasticity, and thus the filling of the mold with the resin by the holding pressure is effectively performed, and the sink marks are prevented from occurring without burr. On the other hand, when the ratio (E′f80/E″f80) at the temperature of 80° C. is 15 or more, the resin composition has moderate viscosity, and thus the sink marks are prevented from occurring without generating of the excessive residual stress. With this, the resin molded article with high dimensional accuracy may be formed.

Ratio (E′f90/E″f90) at Temperature of 90° C.

The ratio (E′f90/E″f90) of storage modulus E′f90 to loss modulus E″f90 at the frequency of 1 Hz and at the temperature of 90° C. is preferably from 3 to 12, is more preferably from 4 to 11, and is still more preferably from 5 to 10.

The storage modulus E′f90 and loss modulus E″f90 at the higher temperature of 90° C. indicates the viscoelasticity in a resin composition in which the resin is in a more glassy state.

When the ratio (E′f90/E″f90) at the temperature of 90° C. is 3 or more, the resin composition has moderate elasticity, and thus the filling of the mold with the resin by the holding pressure is effectively performed, and the sink marks are likely to be prevented from occurring without burr. On the other hand, when the ratio (E′f90/E″f90) at the temperature of 90° C. is 12 or less, the resin composition has moderate viscosity, and thus the sink marks are prevented from occurring without generating of the excessive residual stress. With this, the resin molded article with high dimensional accuracy is likely to be formed.

[(E′f80/E″f80)/(E′f90/E″f90)]

A value [(E′f80/E″f80)/(E/90/E″f90)] of a ratio (E′f80/E″f80) at a temperature of 80° C. to a ratio (E′f90/E″f90) at a temperature of 90° C. is preferably from 1.15 to 1.35, is more preferably from 1.16 to 1.3, and is still more preferably from 1.17 to 1.28.

A ratio of the ratio (E′f90/E″f90) indicating the viscoelasticity at the temperature of 90° C. to the ratio (E′f80/E″f80) indicating the viscoelasticity at the temperature of 80° C. is an index of the rate of change of the viscoelasticity in the resin composition when the temperature is decreased from 90° C. to 80° C. Then, setting this ratio [(E′f80/E″f80)/(E′f90/E″f90)] to be within the above range means that the change of the viscoelasticity in the resin composition is moderate when the temperature is decreased from 90° C. to 80° C.

When the ratio [(E′f80/E″f80)/(E′f90/E″f90)] is 1.35 or less, it means that the elasticity does not become excessively strong due to the decrease in the temperature, and the resin composition has moderate viscosity and elasticity, the sink marks are likely to be prevented from occurring without generating excessive residual stress at the time of filling the mold with the resin by the holding pressure. In addition, when the ratio [(E′f80/E″f80)/(E′f90/E″f90)] is 1.15 or more, it means that the elasticity becomes stronger as the temperature is decreased, and due to the resin composition having the moderate elasticity, the filling of the mold with the resin by the holding pressure is effectively performed, and the sink marks are likely to be prevented from occurring without burr. With this, the resin molded article with high dimensional accuracy is likely to be formed.

[(E′f25/E″f25)/(E′f80/E″f80)]

A value [(E′f25/E″f25)/(E′f80/E″f80)] of a ratio (E′f25/E″f25) at a temperature of 25° C. to a ratio (E′f80/E″f80) at a temperature of 80° C. is preferably from 1.4 to 3.5, is more preferably from 1.5 to 3, and is still more preferably from 1.6 to 2.5.

A ratio of the ratio (E′f80/E″f80) indicating the viscoelasticity at the temperature of 80° C. to the ratio (E′f25/E″f25) indicating the viscoelasticity at the temperature of 25° C. is an index of the rate of change of the viscoelasticity in the resin composition when the temperature is decreased from 80° C. to 25° C. Then, setting this ratio [(E′f25/E″f25)/(E′f80/E″f80)] to be within the above range means that the change of the viscoelasticity in the resin composition is moderately gentle when the temperature is decreased from 80° C. to 25° C., that is, to the temperature at which the solidification is completed.

Setting the ratio [(E′f25/E″f25)/(E′f80/E″f80)] to be 3.5 or less means that the elasticity at the temperature of 80° C. is not excessively small and the viscosity is not excessively large with respect to the viscoelasticity at the temperature of 25° C. at which solidification is completed, in other words, it means that excessive solidification does not occur in a process of cooling from 80° C. to 25° C. With this, the filling of the mold with the resin by the holding pressure is effectively performed, and the sink marks are likely to be prevented from occurring without burr, and the sink marks are likely to be prevented from occurring without generating excessive residual stress so as to form a resin molded article with high dimensional accuracy. In addition, setting the ratio [(E′f25/E″f25)/(E′f80/E″f80)] is 1.4 or less means that the elasticity is sufficiently enhanced and the viscosity is sufficiently reduced at the temperature (25° C.) at which solidification is completed. With this, it possible to prevent the resin molded article from deformed when it is taken out from the mold.

999.e that, the measurement of the above-described “storage modulus E′f80 and loss modulus modulus E″f80 at a frequency of 1 Hz and at a temperature of 80° C.”, “storage modulus E′f90 and loss modulus E″f90 at a frequency of 1 Hz and at a temperature of 90° C.”, and “storage modulus E′f25 and loss modulus E″f25 at a frequency of 1 Hz and at a temperature of 25° C.” is performed by the following method.

A strip test piece (width of 13 mm, length of 50 mm, and thickness of 2 mm) is prepared as a measurement sample and a dynamic viscoelasticity measurement device (DMS 6100, manufactured by Hitachi High-Technologies Corporation.) is used. On the basis of “FIG. 1a) Test method using fixed support test piece” in “Plastics—Determination of dynamic. mechanical properties-. Part 5: Flexural vibration.—Non-resonance method” based on JIS K7244-5:1999, a measurement is performed under the conditions of raising the temperature from 10° C. to the highest attainable temperature (set within the range of 100° C. to 180° C.) at a heating rate of 2° C./min under sinusoidal vibration, measurement frequency of 1 Hz, and nitrogen flow. The values at the temperatures of 25° C., 80° C., and 90° C. are confirmed from each curves of the obtained storage modulus and loss modulus so as to obtain the above-described storage modulus E′f and loss modulus E″f.

A method of controlling the range of the above-described “storage modulus E′f80 and loss modulus E″f80 at a frequency of 1 Hz and at a temperature of 80° C.”, “storage modulus E′f90 and loss modulus E″f90 at a frequency of 1 Hz and at a temperature of 90° C.”, and “storage modulus E′f25 and loss modulus E″f25 at a frequency of 1 Hz and at a temperature of 25° C.” is not particularly limited, and examples thereof include the following methods.

For example, a method of selecting the kinds of bioresin (A), adjusting the kinds of and additional amount of additives (for example, plasticizer (B), and mixture stabilizers (for example, compound (C) which is at least one selected from the group consisting of a hindered phenol compound, a tocopherol compound, a tocotrienol compound, a phosphite compound, and a hydroxylamine compound)), adjusting the kinds of and additional amount of additives other than the aforementioned additives (for example, thermoplastic elastomer (D) and ester compound (E)) and the like may be exemplified.

Hereinafter, the components of the resin composition according to the exemplary embodiment will be described in detail.

### [Resin (A) Having a Biomass-Derived Carbon Atom: Component (A)]

The resin composition according to the exemplary embodiment contains a resin (A) having a biomass-derived carbon atom.

The resin (A) having a biomass-derived carbon atom is not particularly limited, and a known resin having a biomass-derived carbon atom has been used.

In addition, as the resin (A) having a biomass-derived carbon atom, all resins need not necessarily be derived from biomass, and at least a part thereof may have a structure derived from biomass. Specifically, cellulose acylate described below may have a cellulose structure derived from biomass and an acylate structure derived from petroleum.

Note that, “resin having a biomass-derived carbon atom” in the exemplary embodiment is a resin having at least carbon atoms derived from organic resources derived from organisms excluding fossil resources, and as described below, based on the regulation of ASTM D 6866:2012, the presence of the biomass-derived carbon atoms is indicated from the abundance of ¹⁴C.

From the viewpoint of the dimensional accuracy in the obtained resin molded article, the content defined in ASTM D6866:2012 of the biomass-derived carbon in the resin composition according to the exemplary embodiment is preferably 20% by weight or more, is more preferably 30% by weight or more, is still more preferably is 35% by weight by weight or more, and is particularly preferably from 40% by weight to 100% by weight, with respect to the total amount of carbon atoms in the resin composition.

In addition, in the exemplary embodiment, the method of measuring the content of the biomass-derived carbon atom of the resin composition is to calculate the content of the biomass-derived carbon atom by measuring the abundance of ¹⁴C in the total carbon atoms in the resin composition based on the regulation of ASTM D 6866:2012.

Examples of the resin (A) having a biomass-derived carbon atom include cellulose acylate, biomass-derived polyester, biomass-derived polyolefin, biomass-derived polyethylene terephthalate, biomass-derived polyamide, polytrimethylene terephthalate (PTT), polybutylene succinate (PBS), phosphatidylglycerol (PG), an isosorbide polymer, and an acrylic acid modified rosin.

Among them, from the viewpoint of the dimensional accuracy in the resin molded article to be obtained, resin (A) having a biomass-derived carbon atom is preferably at least one selected from the group consisting of cellulose acylate and an aliphatic polyester, and is more preferably cellulose acylate.

### —Cellulose Acylate—

Cellulose acylate is a cellulose derivative in which at least part of the hydroxy group in cellulose is substituted (acylated) with an acyl group. The acyl group is a group having a structure of —CO—R^{AC} (R^{AC} represents a hydrogen atom or a hydrocarbon group).

The cellulose acylate is cellulose derivative represented by Formula (CA).

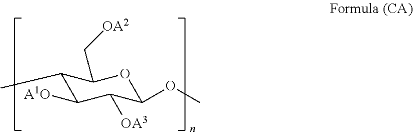

In Formula (CA), A¹, A², and A³ independently represent a hydrogen atom or an acyl group, and n represents an integer of 2 or more. Here, at least a part of n A¹, n A², and n A³ represents an acyl group. All of n A¹ in the molecule may be the same, partly the same, or different from each other. Similarly, all n A² in the molecule may be the same, partly the same, or different from each other and n A³ in the molecule may be the same, partly the same, or different from each other.

In an acyl group represented by A¹, A², and A³, a hydrocarbon group in the acyl group may be linear, branched, or cyclic, but it is preferably linear or branched, and is more preferably linear.

In an acyl group represented by A¹, A², and A³, a hydrocarbon group in the acyl group may be a saturated hydrocarbon group or may be an unsaturated hydrocarbon group, and is more preferably saturated hydrocarbon group.

An acyl group represented by A¹, A², and A³ is preferably an acyl group having 1 to 6 carbon atoms. That is, as cellulose acylate, cellulose acylate having an acyl group with 1 to 6 carbon atoms is preferable. With cellulose acylate having an acyl group with 1 to 6 carbon atoms, it is easy to obtain a resin molded article more excellent in the dimensional accuracy as compared with a case of cellulose acylate having an acyl group having 7 or more carbon atoms.

An acyl group represented by A¹, A², and A³ may be a group in which a hydrogen atom in the acyl group is substituted with a halogen atom (for example, a fluorine atom, a bromine atom, and an iodine atom), an oxygen atom, a nitrogen atom, and is preferably an unsubstituted group.

Examples of acyl group represented by A¹, A², and A³ include a formyl group, an acetyl group, a propionyl group, a butyryl group (a butanoyl group), a propenoyl group, and a hexanoyl group. Among them, from the viewpoint of the formability of the resin composition and the dimensional accuracy of the resin molded article, the acyl group is more preferably an acyl group having 2 to 4 carbon atoms, and is still more preferably an acyl group having 2 or 3 carbon atoms.

Examples of cellulose acylate include cellulose acetate (cellulose monoacetate, cellulose diacetate (DAC), and cellulose triacetate), cellulose acetate propionate (CAP), and cellulose acetate butyrate (CAB).

From the viewpoint of the dimensional accuracy in the obtained resin molded article, cellulose acylate is preferably cellulose acetate propionate (CAP) and cellulose acetate butyrate (CAB), and is more preferably cellulose acetate propionate (CAP).

The cellulose acylate may be used alone or two or more kinds thereof may be used in combination.

A weight average degree of polymerization of cellulose acylate is preferably from 200 to 1000, is more preferably from 500 to 1000, and is still more preferably from 600 to 1000, from the viewpoint of the formability of the resin composition and the dimensional accuracy of the resin molded article to be obtained.

The weight average degree of polymerization of cellulose acylate is determined from the weight average molecular weight (Mw) by the following procedure.

First, the weight average molecular weight (Mw) of cellulose acylate is measured in terms of polystyrene by using tetrahydrofuran with gel permeation chromatography apparatus (GPC apparatus: manufactured by TOSOH CORPORATION, HLC-8320GPC, column: TSKgelα-M).

Next, the weight average molecular weight (Mw) of cellulose acylate is divided by a molecular weight of a constituent unit of cellulose acylate to determine the polymerization degree of cellulose acylate. For example, in a case where the substituent of the cellulose acylate is an acetyl group, the molecular weight of the constituent unit is 263 when the degree of substitution is 2.4 and 284 when the degree of substitution is 2.9.

The weight average molecular weight (Mw) of the resin in the exemplary embodiment is also measured by the same method as the method of measuring the weight average molecular weight of cellulose acylate.

From the viewpoint of the formability of the resin composition and the high dimensional accuracy of the resin molded article to be obtained, the degree of substitution of cellulose acylate is preferably 2.1 to 2.9, is more preferably 2.2 to 2.9, is still more preferably 2.3 to 2.9, and is particularly preferably 2.6 to 2.9.

In the cellulose acetate propionate (CAP), from the viewpoint the moldability of the resin composition and the dimensional accuracy of the resin molded article to be obtained, a ratio of the degree of substitution (acetyl group/propionyl group) of an acetyl group to a propionyl group is preferably 0.01 to 1, and is more preferably 0.05 to 0.1.

As CAP, CAP satisfying at least one of the following (1), (2), (3), and (4) is preferable, and CAP satisfying the following (1), (3), and (4) is more preferable, and CAP satisfying the following (2), (3), and (4) is still more preferable. (1) When measurement is performed by a GPC method with tetrahydrofuran as a solvent, a weight average molecular weight (Mw) in terms of polystyrene is 160,000 to 250,000, and a ratio Mn/Mz of number average molecular weight (Mn) in terms of polystyrene to Z-average molecular weight (Mz) in terms of polystyrene is 0.14 to 0.21. (2) When measurement is performed by a GPC method with tetrahydrofuran as a solvent, a weight average molecular weight (Mw) in terms of polystyrene is 160,000 to 250,000, a ratio Mn/Mz of number average molecular weight (Mn) in terms of polystyrene to Z-average molecular weight (Mz) in terms of polystyrene is 0.14 to 0.21, and a ratio Mw/Mz of a weight average molecular weight (Mw) in terms of polystyrene to Z-average molecular weight (Mz) in terms of polystyrene is 0.3 to 0.7. (3) When measurement is performed with capillograph at 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is 0.1 to 0.3. (4) When a small square plate test piece (D11 test piece specified by JIS K7139:2009, 60 mm×60 mm, thickness of 1 mm) obtained by injection molding of CAP is kept for 48 hours in an atmosphere at a temperature of 65° C. and a relative humidity of 85%, both the expansion coefficient in a MD direction and the expansion coefficient in a TD direction are 0.4% to 0.6%. Here, the MD direction means the length direction of the cavity of the mold used for injection molding, and the TD direction means the direction orthogonal to the MD direction.

In the cellulose acetate butyrate (CAB), from the viewpoint of the formability of the resin composition and the high dimensional accuracy of the resin molded article to be obtained, a ratio of the degree of substitution (acetyl group/butyryl group) of an acetyl group to a butyryl group is preferably 0.05 to 3.5, and is more preferably 0.5 to 3.0.

The degree of substitution of cellulose acylate is an index indicating the degree to which the hydroxy group of cellulose is substituted by an acyl group. In other words, the degree of substitution is an index indicating the degree of acylation of cellulose acylate. Specifically, the degree of substitution means an intramolecular average of the number of substitutions in which three hydroxy groups in the D-glucopyranose unit of cellulose acylate are substituted with an acyl group. The degree of substitution is determined from a ratio of a peak integral of a cellulose-derived hydrogen atom to a peak integral of an acyl group-derived hydrogen atom with ¹H-NMR (JMN-ECA, prepared by JEOL RESONANCE).

—Biomass-Derived Polyester—

Examples of the biomass-derived polyester (hereinafter, also simply referred to “polyester resin”) include a polymer of hydroxyalkanoate (hydroxyalkanoic acid), a polycondensate of polyvalent carboxylic acid and polyhydric alcohol, and a ring-opening polycondensate of cyclic lactam.

The polyester resin is preferably an aliphatic polyester resin. Examples of the aliphatic polyester resin include polyhydroxyalkanoate (a polymer of hydroxyalkanoate) and a polycondensate of aliphatic diol and aliphatic carboxylic acid.

Among them, from the viewpoint of the high dimensional accuracy of the resin molded article to be obtained, polyhydroxyalkanoate is preferable as a polyester resin.

The polyester resin may be used alone, or two or more kinds thereof may be used in combination.

As the polyhydroxyalkanoate, a compound having a structural unit represented by Formula (PHA) may be exemplified.

Note that, in the compound having a structural unit represented by Formula (PHA), both ends of the polymer chain (main chain terminals) may be a carboxyl group, or only one end of the polymer chain may be a carboxyl group and the other end of the polymer chain may be another group (for example, a hydroxy group).

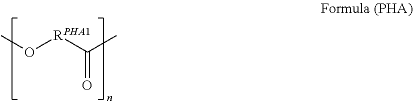

In Formula (PHA), R^{PHA1} represents an alkylene group having 1 to 10 carbon atoms. n represents an integer of 2 or more.

In Formula (PHA), an alkylene group represented by R^{PHA1} is preferably an alkylene group having 3 to 6 carbon atoms. The alkylene group represented by R^{PHA1} may be any one of a linear alkylene group and a branched alkylene group, and is preferably a branched alkylene group.

Here, in Formula (PHA), R^{PHA1} represents an alkylene group, which means that 1) R^{PHA1} has a [O—R^{PHA1}—C(═O)—] structure representing the same alkylene group, 2) R^{PHA1} has plural [O—R^{PHA1}—C(═O)—] structures representing different alkylene groups (R^{PHA1} represents an alkylene group having different carbon atoms or branches) (that is, a [O—R^{PHA1}—C(═O)—] [O—R^{PHA1B}—C(═O)—] structure).

That is, the polyhydroxyalkanoate may be a homopolymer of one kind of hydroxyalkanoate (hydroxyalkanoic acid), or may be a copolymer of two or more kinds of hydroxyalkanoate (hydroxyalkanoic acid).

In Formula (PHA), an upper limit of n is not particularly limited, and is, for example, 20000 or lower. A range of n is preferably from 500 to 10000, and is more preferably from 1000 to 8000.

Examples of the polyhydroxyalkanoate include a homopolymer of hydroxyalkanoic acid (lactic acid, 2-hydroxybutyric acid, 3-hydroxybutyric acid, 4-hydroxybutyric acid, 2-hydroxy-3-methylbutyric acid, 2-hydroxy-3,3-dimethylbutyric acid, 3-hydroxyvaleric acid, 4-hydroxyvaleric acid, 5-hydroxyvaleric acid, 3-hydroxyhexanoic acid, 2-hydroxyhexanoic acid, 2-hydroxyisohexanoic acid, 6-hydroxyhexanoic acid, 3-hydroxypropionic acid, 3-hydroxy-2,2-dimethylpropionic acid, 3-hydroxyhexanoic acid, 2-hydroxy-n-octanoic acid, and the like), or a copolymer of these two or more hydroxyalkanoic acids.

Among them, from the viewpoint of suppressing deterioration in transparency and improving the dimensional accuracy of the resin molded article to be obtained, the polyhydroxyalkanoate is preferably a homopolymer of a branched hydroxyalkanoic acid having 2 to 4 carbon atoms, a single copolymer of a branched hydroxyalkanoic acid having 2 to 4 carbon atoms and a branched hydroxyalkanoic acid having 5 to 7 carbon atoms, is more preferably a homopolymer of branched hydroxyalkanoic acid having 3 carbon atoms (that is, polylactic acid) and a single copolymer of 3-hydroxybutyric acid and 3-hydroxyhexanoic acid (that is, polyhydroxybutyrate hexanoate), and is still more preferably a homopolymer of branched hydroxyalkanoic acid having 3 carbon atoms (that is, polylactic acid).

Note that, the number of carbon atoms of the hydroxyalkanoic acid is the number including the carbon atoms of the carboxyl group.

Polylactic acid is a polymer compound in which lactic acid is polymerized by an ester bond.

Examples of the polylactic acid include a homopolymer of L-lactic acid, a homopolymer of D-lactic acid, a block copolymer including at least one polymer of L-lactic acid and D-lactic acid, and a graft copolymer including at least one polymer of L-lactic acid and D-lactic acid.

Examples of the “compound copolymerizable with L-lactic acid or D-lactic acid” include polyvalent carboxylic acid such as glycolic acid, dimethyl glycolic acid, 3-hydroxybutyric acid, 4-hydroxybutyric acid, 2-hydroxypropanoic acid, 3-hydroxypropanoic acid, 2-hydroxyvaleric acid, 3-hydroxyvaleric acid, 4-hydroxyvaleric acid, oxalic acid, malonic acid, succinic acid, glutaric acid, adipic acid, pimelic acid, azelaic acid, sebacic acid, undecanedioic acid, dodecanedioic acid, terephthalic acid, and anhydride thereof; polyhydric alcohol such as ethylene glycol, diethylene glycol, triethylene glycol, 1,2-propanediol, 1,3-propanediol, 1,3-butanediol, 1,4-butanediol, 2,3-butanediol, 1,5-pentanediol, 1,6-hexanediol, 1,9-nonanediol, 3-methyl-1,5-pentanediol, neopentyl glycol, tetramethylene glycol, and 1,4-hexanedimethanol; polysaccharides such as cellulose; amino carboxylic acids such as α-amino acid; hydroxycarboxylic acid such as 5-hydroxyvaleric acid, 2-hydroxycaproic acid, 3-hydroxycaproic acid, 4-hydroxycaproic acid, 5-hydroxycaproic acid, 6-hydroxycaproic acid, 6-hydroxymethylcaproic acid, and mandelic acid; and cyclic ester such as glycolide, β-methyl-δ-valerolactone, γ-valerolactone, and ε-caprolactone.

It is known that polylactic acid may be produced by a lactide method via lactide; a direct polymerization method in which lactic acid is heated under reduced pressure in a solvent and polymerized while removing water; or the like.

In polyhydroxybutyrate hexanoate, from the viewpoint of the dimensional accuracy of the resin molded article to be obtained, a copolymerization ratio of 3-hydroxyhexanoic acid (3-hydroxyhexanoate) to a copolymer of 3-hydroxybutyric acid (3-hydroxybutyrate) and 3-hydroxyhexanoic acid (3-hydroxyhexanoate) is preferably from 3% by mol to 20% by mol, is more preferably from 4% by mol to 15% by mol, and is still more preferably 5% by mol to 12% by mol.

In a method of measuring the copolymerization ratio of 3-hydroxyhexanoic acid (3-hydroxyhexanoate), the hexanoate ratio is calculated from a value of a peak integral derived from a hexanoate end and a value of a peak integral derived from a butyrate end using ¹H-NMR.

From the viewpoint of the dimensional accuracy of the resin molded article to be obtained, the weight average molecular weight (Mw) of the polyester resin may be from 10,000 to 1,000,000 (preferably from 50,000 to 800,000, and more preferably from 100,000 to 600,000).

The weight average molecular weight (Mw) of the polyester resin is a value measured by gel permeation chromatography (GPC). Specifically, by using HLC-8320 GPC as a measuring device, manufactured by Tosoh Corporation, the molecular weight measurement by GPC is performed with a chloroform solvent using a column/TSKgel GMHHR-M+TSKgel GMHHR-M (7.8 mml. D. 30 cm) manufactured by Tosoh Corporation. The weight average molecular weight (Mw) is calculated from this measurement result by using a molecular weight calibration curve prepared from a monodisperse polystyrene standard sample.

Resin (A) having a biomass-derived carbon atom may be used alone, or two or more kinds thereof may be used in combination.

### [Plasticizer (C): Component (C)]

Examples of plasticizer (C) include a cardanol compound, an ester compound other than ester compound (E) described below, camphor, metal soap, polyol, and polyalkylene oxide. As plasticizer (C), a cardanol compound is preferable from the viewpoint of the dimensional accuracy of the resin molded article, or an ester compound other than ester compound (E) described below is preferable.

Plasticizer (C) may be used alone or two or more kinds thereof may be used in combination.

From the viewpoint that it is easy to obtain the effect of improving the toughness by adding ester compound (E), plasticizer (C) is preferably a cardanol compound or an ester compound other than ester compound (E). Hereinafter, the cardanol compound and the ester compound suitable as plasticizer (C) will be specifically described.

—Cardanol Compound—

The cardanol compound refers to a component (for example, a compound represented by Formulae (c-1) to (c-4)) contained in a nature derived-compounds derived from a cashew or a derivative from the above-described component.

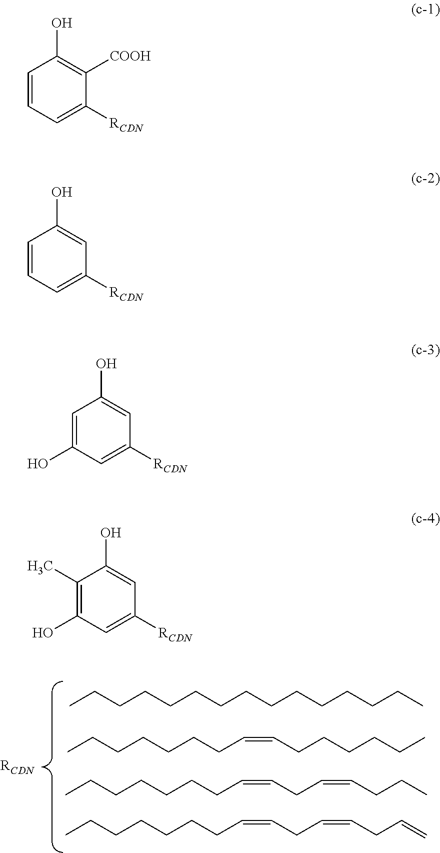

The cardanol compound may be used alone or two or more kinds thereof may be used in combination.

The resin composition according to the exemplary embodiment may contain a mixture of nature derived-compounds derived from a cashew as a cardanol compound (hereinafter, also referred to as “cashew-derived mixture”)

The resin composition according to the exemplary embodiment may contain a derivative from a cashew-derived mixture as a cardanol compound. As the derivative from the cashew-derived mixture, for example, the following mixtures and pure substances may be exemplified.
A mixture prepared by adjusting the composition ratio of each component in the cashew-derived mixture
A pure substance which is a specific component isolated from the cashew-derived mixture
A mixture containing a modified product obtained by modifying components in the cashew-derived mixture
A mixture containing a polymer obtained by polymerizing components in the cashew-derived mixture
A mixture containing a modified polymer obtained by modifying and polymerizing a component in the cashew-derived mixture
A mixture containing a modified product obtained by further modifying components in the mixture prepared by adjusting the composition ratio of each component in the cashew-derived mixture
A mixture containing a polymer obtained by further polymerizing the components in the mixture prepared by adjusting the composition ratio of each component in the cashew-derived mixture
A mixture containing a modified polymer obtained by further modifying and polymerizing the components in the mixture prepared by adjusting the composition ratio of each component in the cashew-derived mixture
Modified product obtained by further modifying a pure substance
A polymer obtained by further polymerizing the pure substance
A modified polymer obtained by further modifying and polymerizing the pure substance

Here, a single substance includes a multimer such as a dimer and a trimer.

From the viewpoint of the dimensional accuracy of the resin molded article, the cardanol compound is preferably at least one compound selected from the group consisting of polymers obtained by polymerizing a compound represented by Formula (CDN1) and a compound represented by Formula (CDN1).

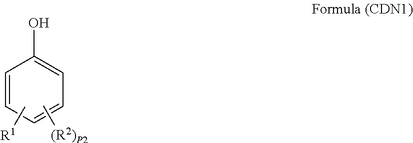

In Formula (CDN1), R¹ represents an alkyl group which may have a substituent or an unsaturated aliphatic group which has a double bond and may have a substituent. R² represents a hydroxy group, a carboxy group, an alkyl group which may have a substituent, or an unsaturated aliphatic group which has a double bond and may have a substituent. P2 represents an integer of 0 to 4. Each of R² present in plural in a case where P2 is 2 or more may be the same group or different group.

In Formula (CDN1), the alkyl group which may have a substituent represented by R¹ is preferably an alkyl group having 3 to 30 carbon atoms, is more preferably an alkyl group having 5 to 25 carbon atoms, is still more preferably an alkyl group having 8 to 20 carbon atoms.

Examples of the substituent include a hydroxy group; a substituent containing an ether bond such as an epoxy group and a methoxy group; and a substituent containing an ester bond such as an acetyl group and a propionyl group.

Examples of the alkyl group which may have a substituent include a pentadecan-1-yl group, a heptan-1-yl group, an octan-1-yl group, a nonan-1-yl group, a decan-1-yl group, an undecan-1-yl group, dodecan-1-yl group, and a tetradecan-1-yl group.

In Formula (CDN1), the unsaturated aliphatic group which has a double bond and may have a substituent represented by R¹ is preferably an unsaturated aliphatic group having 3 to 30 carbon atoms, is more preferably an unsaturated aliphatic group having 5 to 25 carbon atoms, and is still more preferably an unsaturated aliphatic group having 8 to 20 carbon atoms.

The number of double bonds contained in the unsaturated aliphatic group is preferably 1 to 3.

Examples of the substituent include the same substituents as those of the alkyl group.

Examples of the unsaturated aliphatic group which has a double bond and may have a substituent include a pentadeca-8-en-1-yl group, a pentadeca-8,11-dien-1-yl group, a pentadeca-8, 11, 14-trien-1-yl group, a pentadeca-7-en-1-yl group, a pentadeca-7,10-dien-1-yl group, and a pentadeca-7,10,14-trien-1-yl group.

In Formula (CDN1), as R¹, a pentadeca-8-en-1-yl group, a pentadeca-8,11-dien-1-yl group, a pentadeca-8, 11, 14-trien-1-yl group, a pentadeca-7-en-1-yl group, a pentadeca-7,10-dien-1-yl group, and a pentadeca-7,10,14-trien-1-yl group are preferable.

In Formula (CDN1), examples of the alkyl group which may have a substituent and the unsaturated aliphatic group which has a double bond and may have a substituent represented by R² are the same as those of the alkyl group which may have a substituent and the unsaturated aliphatic group which has a double bond and may have a substituent represented by R¹.

The compound represented by Formula (CDN1) may be further modified. For example, it may be epoxidized, specifically, a compound having a structure in which the hydroxy group of the compound represented by Formula (CDN1) is replaced with the following group (EP), that is, a compound represented by the following Formula (CDN1-e).

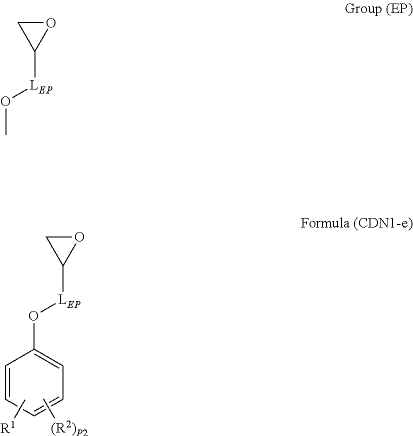

In group (EP) and Formula (CDN1-e), L_{EP} represents a single bond or a divalent linking group. In Formula (CDN1-e), each of the R¹, R², and P2 is the same as R′, R², and P2 in Formula (CDN1), respectively.

In group (EP) and Formula (CDN1-e), examples of the divalent linking group represented by L_{EP} include an alkylene group which may have a substituent (preferably an alkylene group having 1 to 4 carbon atoms, and more preferably an alkylene group having 1 carbon atom), and a —CH₂CH₂OCH₂CH₂— group.

Examples of the substituent include the same substituents as those in R¹ of Formula (CDN1).

As L_{EP}, a methylene group is preferable.

The polymer in which the compound represented by Formula (CDN1) is polymerized is a polymer in which at least two or more compounds represented by Formula (CDN1) are polymerized with or without a linking group.

As a polymer obtained by polymerizing a compound represented by Formula (CDN1), for example, a compound represented by Formula (CDN2) may be exemplified.

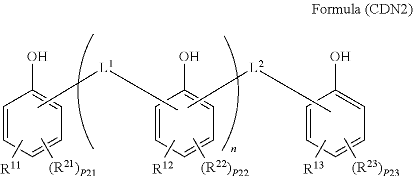

In Formula (CDN2), R¹¹, R¹², and R¹³ each independently represents an alkyl group which may have a substituent or an unsaturated aliphatic group which has a double bond and may have a substituent. R²¹, R²² and R²³ each independently represents a hydroxy group, a carboxy group, an alkyl group which may have a substituent, or an unsaturated aliphatic group which has a double bond and may have a substituent. P21 and P23 each independently represent an integer of 0 to 3, and P22 represents an integer of 0 to 2. L¹ and L² each independently represents a divalent linking group. n represents an integer of 0 to 10. R²¹ present in plural in a case where P21 is 2 or more may be the same group or different group, R²² present in plural in a case where P22 is 2 or more may be the same group or different group, and R²³ present in plural in a case where P23 is 2 or more may be the same group or different group. R¹² present in plural in a case where n is 2 or more may be the same group or different group, R²² present in plural in a case where n is 2 or more may be the same group or different group, and L¹ present in plural in a case where n is 2 or more may be the same group or different group, and P22 present in plural in a case where n is 2 or more may be the same number or different numbers.

In Formula (CDN2), as the alkyl group which may have a substituent and the unsaturated aliphatic group which has a double bond and may have a substituent, which are represented by R¹¹, R¹², R¹³, R²¹, R²², and R²³, the same groups exemplified as R¹ in Formula (CDN1) are preferably exemplified.

In Formula (CDN2), examples of the divalent linking group represented by L¹ and L² include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

In Formula (CDN2), n is preferably 1 to 10, and is more preferably 1 to 5.

The compound represented by Formula (CDN2) may be further modified. For example, it may be epoxidized, specifically, a compound having a structure in which the hydroxy group of the compound represented by Formula (CDN2) is replaced with the following group (EP), that is, a compound represented by the following Formula (CDN2-e).

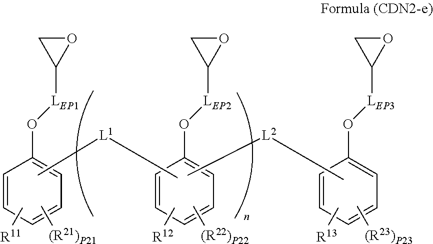

In Formula (CDN2-e), each of R¹¹, R¹², R¹³, R²¹, R²², R²³, P21, P22, P23, L¹, L² and n is the same as R¹¹, R¹², R¹³, R²¹, R²², R²³, P21, P22, P23, L¹, and L² and n in Formula (CDN2), respectively.

In Formula (CDN2-e), L_{EP1}, L_{EP2}, and L_{EP3} each independently represent a single bond or a divalent linking group. Each of L_{EP2} present in plural in a case where n is 2 or more may be the same group or different group.

In Formula (CDN2-e), as the divalent linking group represented by L_{EP1}, L_{EP2}, and L_{EP3}, the same groups exemplified as the divalent linking group represented by L_{EP} in Formula (CDN1-e) are preferably exemplified.

The polymer in which the compound represented by Formula (CDN1) is polymerized may be, for example, a polymer in which at least three or more compounds represented by Formula (CDN1) are three-dimensionally crosslinked and polymerized with or without a linking group. Examples of the polymer in which the compound represented by Formula (CDN1) is three-dimensionally crosslinked and polymerized include compounds represented by the following Formula.

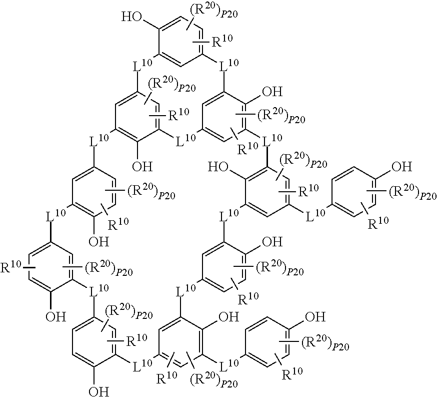

In the Formula, each of the R¹⁰, R²⁰, and P20 is the same as R¹, R², and P2 in Formula (CDN1). L¹⁰ represents a single bond or a divalent linking group. R¹⁰ present in plural may be the same group or different group, R²⁰ present in plural may be the same group or different group, and L¹⁰ present in plural may be the same group or different group. P20 present in plural may be the same number or different numbers.

In the Formula, examples of the divalent linking group represented by L¹⁰ include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

The compound represented by the Formula may be further modified, for example, it may be epoxidized. Specifically, it may be a compound having a structure in which the hydroxy group of the compound represented by the Formula is substituted with group (EP), and examples thereof include compounds represented by the following Formula, that is, polymer in which the compound represented by Formula (CDN1-e) is three-dimensionally crosslinked and polymerized.

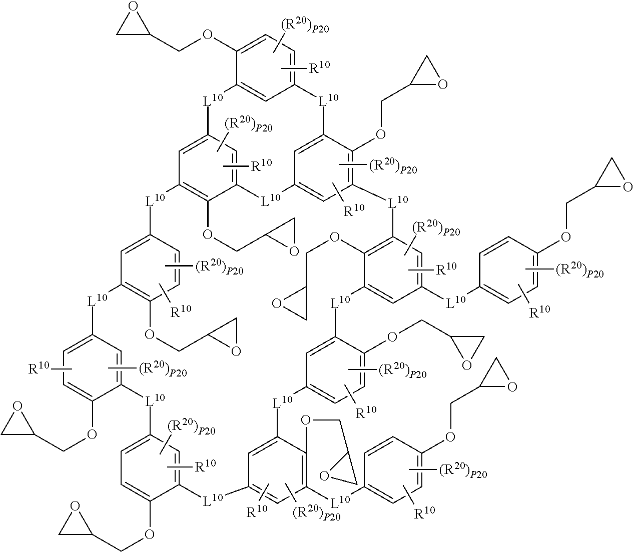

In the Formula, each of the R¹⁰, R²⁰ and P20 is the same as R¹, R², and P2 in Formula (CDN1-e), respectively. L¹⁰ represents a single bond or a divalent linking group. R¹⁰ present in plural may be the same group or different group, R²⁰ present in plural may be the same group or different group, and L¹⁰ present in plural may be the same group or different group. P20 present in plural may be the same number or different numbers.

In the Formula, examples of the divalent linking group represented by L¹⁰ include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

From the viewpoint of improving the dimensional accuracy of the resin molded article, the cardanol compound preferably contains a cardanol compound having an epoxy group, and is more preferably a cardanol compound having an epoxy group.

As the cardanol compound, commercially available products may be used. Examples of the commercially available products include NX-2024, Ultra LITE 2023, NX-2026, GX-2503, NC-510, LITE 2020, NX-9001, NX-9004, NX-9007, NX-9008, NX-9201, and NX-9203, which are prepared by Cardolite, and LB-7000, LB-7250, and CD-5L which are prepared by Tohoku Chemical Industries, Ltd. Examples of the commercially available products of the cardanol compound having an epoxy group include NC-513, NC-514S, NC-547, LITE513E, and Ultra LTE 513, which are prepared by Cardolite.

From the viewpoint of the dimensional accuracy of the resin molded article, a hydroxyl value of the cardanol compound is preferably 100 mgKOH/g or more, is more preferably 120 mgKOH/g, and is still more preferably 150 mgKOH/g. The hydroxyl value of the cardanol compound is performed in accordance with an A method of ISO14900.

In a case where a cardanol compound having an epoxy group is used as a cardanol compound, from the viewpoint of improving the dimensional accuracy of the resin molded article, an epoxy equivalent is preferably 300 to 500, is more preferably 350 to 480, and is still more preferably 400 to 470. The measurement of the epoxy equivalent of the cardanol compound having an epoxy group is performed in accordance with ISO3001.

The molecular weight of the cardanol compound is preferably from 250 to 1,000, is more preferably from 280 to 900, and is still more preferably from 300 to 800, from the viewpoint of easily obtaining the effect of improving the toughness by adding component (B).

### —Ester Compound—

An ester compound contained in the resin composition according to the exemplary embodiment as plasticizer (C) is not particularly limited as long as it is an ester compound other than the compound represented by Formulae (1) to (5).

Examples of the ester compound contained as plasticizer (C) include dicarboxylic acid diester, citric acid ester, a polyetherester compound, benzoic acid glycol ester, a compound represented by Formula (6), and epoxidized fatty acid ester. Examples of these esters include monoesters, diesters, triesters, and polyesters.

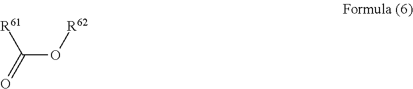

In Formula (6), R⁶¹ represents an aliphatic hydrocarbon group having 7 to 28 carbon atoms and R⁶² represents an aliphatic hydrocarbon group having 1 to 8 carbon atoms.

As a specific form and preferable form of the group represented by R⁶¹, the same form as that of the group represented by R¹¹ in Formula (1) is exemplified.

The group represented by R⁶² may be a saturated aliphatic hydrocarbon group or may an unsaturated aliphatic hydrocarbon group, and is preferably a saturated aliphatic hydrocarbon group. The group represented by R⁶² may be a linear aliphatic hydrocarbon group, may be a branched aliphatic hydrocarbon group, may be an aliphatic hydrocarbon group containing an alicyclic ring, and is preferably a branched aliphatic hydrocarbon group. The group represented by R⁶² may be a group in which a hydrogen atom in an aliphatic hydrocarbon group is substituted with a halogen atom (for example, a fluorine atom, a bromine atom, and an iodine atom), an oxygen atom, a nitrogen atom, and is preferably an unsubstituted group. The group represented by R⁶² preferably has 2 or more carbon atoms, more preferably has 3 or more carbon atoms, and still more preferably has 4 or more carbon atoms.

Specific examples of the ester compound contained as plasticizer (C) include adipic acid ester, citric acid ester, sebacic acid ester, azelaic acid ester, phthalic acid ester, acetic acid ester, dibasic acid ester, phosphate ester, condensed phosphate ester, glycol ester (for example, benzoic acid glycol ester), and a modified article of fatty acid ester (for example, epoxidized fatty acid ester). Examples of the above ester include monoester, diester, triester, and polyester. Among them, dicarboxylic acid diester (adipic acid diester, sebacic acid diester, azelaic acid diester, phthalic acid diester, and the like) are preferable.

In the ester compound contained in the resin composition according to the exemplary embodiment as plasticizer (C), the molecular weight (or weight average molecular weight) is preferably from 200 to 2000, is more preferably from 250 to 1500, and is still more preferably from 280 to 1000. The weight average molecular weight of the ester compound is a value measured according to the method of measuring the weight average molecular weight of cellulose acylate (A), unless otherwise specified.

As plasticizer (C), adipic acid ester is preferable. The adipic acid ester has high affinity with cellulose acylate (A), and is dispersed in a state of nearly uniform to cellulose acylate (A), so that the thermal fluidity is improved more than other plasticizers (C).

Examples of the adipic acid ester include adipic acid diester and adipic acid polyester. Specific examples thereof include adipic acid diester represented by Formula (AE) and adipic acid polyester represented by Formula (APE).

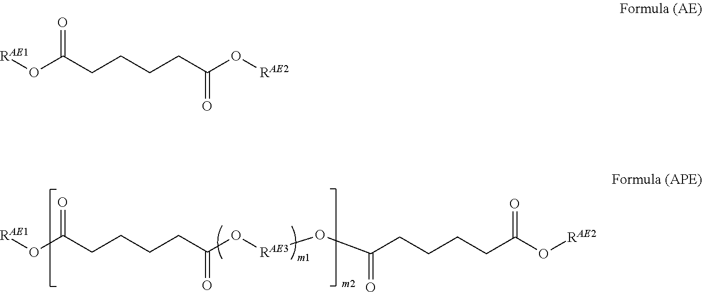

In Formula (AE), R^{AE1} and R^{AE2} each independently represent an alkyl group or a polyoxyalkyl group [—(CₓH₂ₓ—O)_{y}—R^{A1}] (here, R^{A1} represents an alkyl group, x represents an integer of 1 to 10, and y represents an integer of 1 to 10).

In Formula (APE), R^{AE1} and R^{AE2} each independently an alkyl group or a polyoxyalkyl group [—(CₓH₂ₓ—O)_{y}—R^{A1}] (here, R^{A1} represents an alkyl group, x represents an integer of 1 to 10, and y represents an integer of 1 to 10), and R^{AE3} represents an alkylene group. m1 represents an integer of 1 to 10 and m2 represents an integer of 1 to 20.

In Formula (AE) and (APE), an alkyl group represented by R^{AE1} and R^{AE2} is preferably an alkyl group having 1 to 12 carbon atoms, is more preferably an alkyl group having 4 to 10 carbon atoms, and is still more preferably an alkyl group having 8 carbon atoms. The alkyl group represented by R^{AE1} and R^{AE2} may be any one of a linear alkyl group, a branched alkyl group, and a cyclic alkyl group, and is preferably a linear alkyl group or a branched alkyl group.

In Formula (AE) and (APE), in the polyoxyalkyl group [—(CₓH₂ₓ—O)_{y}—R^{A1}] represented by R^{AE1} and R^{AE2}, an alkyl group represented by R^{A1} is preferably an alkyl group having 1 to 6 carbon atoms, and is more preferably an alkyl group having 1 to 4 carbon atoms. The alkyl group represented by R^{A1} may be any one of a linear alkyl group, a branched alkyl group, and a cyclic alkyl group, and is preferably a linear alkyl group or a branched alkyl group.

In Formula (APE), an alkylene group represented by R^{AE3} is preferably an alkylene group having 1 to 6 carbon atoms and is more preferably an alkylene group having 1 to 4 carbon atoms. The alkylene group may be any one of a linear alkylene group, a branched alkylene group, and a cyclic alkylene group, and is preferably a linear alkylene group or a branched alkyl group.

In Formula (APE), m1 is preferably an integer of 1 to 5 and m2 is preferably an integer of 1 to 10.

In Formulae (AE) and (APE), the group represented by each code may be substituted with a substituent. Examples of the substituent include an alkyl group, an aryl group, and a hydroxy group.

The molecular weight of adipic acid ester (or weight average molecular weight) is preferably from 250 to 2000, is more preferably from 280 to 1500, and still more preferably from 300 to 1000. The weight average molecular weight of adipic acid ester is a value measured according to the method of measuring the weight average molecular weight of cellulose acylate (A).

As the adipic acid ester, a mixture of adipic acid ester and other components may be used. As a commercially available product of the mixture, Daifatty 101 prepared by Daihachi Chemical Industry Co., Ltd., and the like may be exemplified.

As a hydrocarbon group at a terminal in fatty acid ester such as citric acid ester, sebacic acid ester, azelaic acid ester, phthalic acid ester, and acetic acid ester, an aliphatic hydrocarbon group is preferable, an alkyl group having 1 to 12 carbon atoms is preferable, an alkyl group having 4 to 10 carbon atoms is more preferable, and an alkyl group having 8 carbon atoms is still more preferable. The alkyl group may be any one of a linear alkyl group, a branched alkyl group, and a cyclic alkyl group, and is preferably a linear alkyl group or a branched alkyl group.

Examples of the fatty acid ester such as citric acid ester, sebacic acid ester, azelaic acid ester, phthalic acid ester, and acetic acid ester include ester of fatty acid and alcohol. Examples of alcohol include monohydric alcohols such as methanol, ethanol, propanol, butanol, and 2-ethyl hexanol; and polyhydric alcohol such as glycerin, polyglycerine (diglycerin and the like), pentaerythritol, ethylene glycol, diethylene glycol, propylene glycol, butylene glycol, trimethylolpropane, trimethylol ethane, and sugar alcohol.

Examples of glycol in benzoic acid glycol ester include ethylene glycol, diethylene glycol, and propylene glycol.

The epoxidized fatty acid ester is an ester compound having a structure (that is, oxacyclopropane) in which carbon-carbon unsaturated bonds of unsaturated fatty acid esters are epoxidized. Examples of the epoxidized fatty acid ester include ester of fatty acid and alcohol in which some or all of the carbon-carbon unsaturated bonds are epoxidized in the unsaturated fatty acid (for example, oleic acid, palmitoleic acid, vaccenic acid, linoleic acid, linolenic acid, and nervonic acid). Examples of alcohol include monohydric alcohols such as methanol, ethanol, propanol, butanol, and 2-ethyl hexanol; and polyhydric alcohol such as glycerin, polyglycerine (diglycerin and the like), pentaerythritol, ethylene glycol, diethylene glycol, propylene glycol, butylene glycol, trimethylolpropane, trimethylol ethane, and sugar alcohol.

Examples of the commercially available product of the epoxidized fatty acid ester include ADEKA CIZER D-32, D-55, O-130P, and O-180A (prepared by ADEKA CORPORATION), SANSO CIZER E-PS, nE-PS, E-PO, E-4030, E-6000, E-2000H, and E-9000H (prepared by New Japan Chemical Co., Ltd.).

A polyester unit of the polyetherester compound may be either aromatic or aliphatic (including alicyclic) and a polyether unit of the polyetherester compound may be either aromatic or aliphatic (including alicyclic). A weight ratio of the polyester unit to the polyether unit is, for example, 20:80 to 80:20. The molecular weight (or weight average molecular weight) of the polyetherester compound is preferably from 250 to 2000, is more preferably from 280 to 1500, and still more preferably from 300 to 1000. Examples of the commercially available product of the polyetherester compound include ADEKA CIZER RS-1000 (prepared by ADEKA CORPORATION).

As a polyether compound having at least one unsaturated bond in a molecule, a polyether compound having an allyl group at a terminal thereof is exemplified, and polyalkylene glycol allyl ether is preferable. A molecular weight (or weight average molecular weight) of the polyether compound having at least one unsaturated bond in a molecule is preferably from 250 to 2000, is more preferably from 280 to 1500, and is still more preferably from 300 to 1000. Examples of the commercially available product of the polyether compound having at least one unsaturated bond in a molecule include polyalkylene glycol allyl ether such as UNIOX PKA-5006, UNIOX PKA-5008, UNIOL PKA-5014, UNIOL PKA-5017 (prepared by NOF CORPORATION).

<<Compound (C) which is at Least One Selected from the Group Consisting of a Hindered Phenol Compound, Tocopherol Compound, Tocotrienol Compound, Phosphite Compound, and Hydroxyl Amine Compound: Component (C)>>

The resin composition according to the exemplary embodiment further contains compound (C).

Compound (C) is at least one selected from the group consisting of a hindered phenol compound, a tocopherol compound, a tocotrienol compound, a phosphite compound, and a hydroxylamine compound.

These compounds (C) function, for example, as stabilizers (mixing stabilizers) when mixing various additives in the bioresin (A), and make it easier to increase the dimensional accuracy of the resin molded article.

### —Hindered Phenol Compound—

The hindered phenol compound in the exemplary embodiment means a compound in which at least one of the ortho positions relative to a hydroxy group of a phenol is substituted with an alkyl group. The alkyl group is preferably a bulky alkyl group such as a tert-butyl group or a tert-pentyl group (1,1-dimethyl propyl group).

Examples of the hindered phenol compound include a compound represented by Formula (HP1).

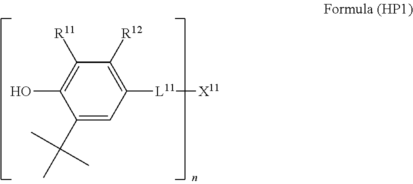

In Formula (HP1), R¹¹ and R¹² each independently represent a hydrogen atom or an alkyl group having 1 to 6 carbon atoms, L¹¹ represents a single bond or a divalent linking group, X¹¹ represents a single bond or an n-valent group, n represents 1, 2, 3, or 4.

As the alkyl group having 1 to 6 carbon atoms represented by R¹¹, an alkyl group having 1 to 5 carbon atoms is preferable, and an alkyl group having 1 to 4 carbon atoms is more preferable. As an alkyl group having 1 to 6 carbon atoms represented by R¹¹ may be linear, branched, or cyclic, and is preferably a linear or branched alkyl group.

As the alkyl group having 1 to 6 carbon atoms represented by R¹¹, specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, and a 1,1-dimethyl butyl group is preferable, a methyl group, a tert-butyl group, or a tert-pentyl group is more preferable, and a methyl group or a tert-butyl group is still more preferable.

As the alkyl group having 1 to 6 carbon atoms represented by R¹², an alkyl group having 1 to 3 carbon atoms is preferable, and an alkyl group having 1 or 2 carbon atoms is more preferable. As an alkyl group having 1 to 6 carbon atoms represented by R¹² may be linear, branched, or cyclic, and is preferably a linear or branched alkyl group.

As the alkyl group having 1 to 6 carbon atoms represented by R¹², specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, and a 1,1-dimethyl butyl group are preferable, a methyl group, an ethyl group, an n-propyl group or isopropyl group is more preferable, and a methyl group or an ethyl group is still more preferable.

As a group represented by R¹¹, a hydrogen atom, a methyl group, a tert-butyl group, or a tert-pentyl group is preferable.

As a group represented by R¹², a hydrogen atom, a methyl group, or an ethyl group is preferable.

R¹¹ and R¹² may be bonded to each other to form a ring.

As a divalent linking group represented by L¹¹, an alkylene group having 1 to 6 carbon atoms (preferably an alkylene group having 1 to 4 carbon atoms), —R—C(═O)O—R′—, and the like may be exemplified. Here, R and R′ each independently represent an alkylene group having 1 to 6 carbon atoms (preferably an alkylene group having 1 to 4 carbon atoms, and more preferably an alkylene group having 1 or 2 carbon atoms) or a phenylene group.

—R—C(═O)O—R′— is preferably —CH₂CH₂—C(═O)O—CH₂—.

As a monovalent group represented by X¹¹, an aliphatic hydrocarbon group may be exemplified.

The aliphatic hydrocarbon group may be linear, branched, or may contain an alicyclic ring. From the viewpoint that a compound represented by Formula (HP1) is likely to be dispersed in bioresin (A) and the viewpoint of the high dimensional accuracy, the aliphatic hydrocarbon group is preferably an aliphatic hydrocarbon group not containing an alicyclic group (that is, a chain aliphatic hydrocarbon group), and is more preferably a linear aliphatic hydrocarbon group.

The aliphatic hydrocarbon group may be a saturated aliphatic hydrocarbon group, and an unsaturated aliphatic hydrocarbon group. From the viewpoint that a compound represented by Formula (HP1) is likely to be dispersed in bioresin (A) and the viewpoint of the high dimensional accuracy, an aliphatic hydrocarbon group is preferably a saturated aliphatic hydrocarbon group.

From the viewpoint that a compound represented by Formula (HP1) is likely to be dispersed in bioresin (A) and the viewpoint of the high dimensional accuracy, the number of carbon atoms of the aliphatic hydrocarbon group is preferably from 1 to 24, and is more preferably from 6 to 20, and is still more preferably from 12 to 18.

Specific examples of the aliphatic hydrocarbon group include the same groups as those described for Y⁴¹ in Formula (P1) described later.

Specific examples of the aliphatic hydrocarbon group include a linear alkyl group having 6 to 20 carbon atoms is preferable, a linear alkyl group having 12 to 18 carbon atoms is more preferable, and a linear alkyl group having 16 to 18 carbon atoms is still more preferable.

As a divalent group represented by X¹¹, a group (alkanediyl group) obtained by removing two hydrogen atoms from alkane having 1 to 6 carbon atoms (preferably alkane having 1 to 4 carbon atoms) and —(R—O—R′)ₘ— may be exemplified. Here, each of R and R′ independently represent an alkylene group having 1 to 4 carbon atoms or a phenylene group, and m represents 1, 2, 3, or 4 (preferably 1 or 2).

—(R—O—R′)ₘ— is preferably —CH₂—O—CH₂— or —(CH₂—O—CH₂)₂—.

As a divalent group represented by X¹¹, the following group (HP1-a) may be also exemplified. * represents a bonding position with L¹¹.

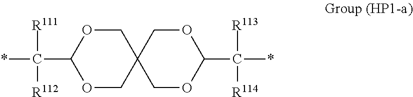

In the group (HP1-a), R¹¹¹, R¹¹², R¹¹³, and R¹¹⁴ each independently represent a hydrogen atom or an alkyl group having 1 to 4 carbon atoms. The alkyl group having 1 to 4 carbon atoms is preferably a methyl group, an ethyl group, an n-propyl group, an isopropyl group, an n-butyl group, a sec-butyl group, an isobutyl group, or a tert-butyl group, is more preferably a methyl group or an ethyl group, and is still more preferably a methyl group.

As a trivalent group represented by X¹¹, a group (alkanetriyl group) obtained by removing three hydrogen atoms from alkane having 1 to 6 carbon atoms (preferably alkane having 1 to 4 carbon atoms) may be exemplified.

As the trivalent group represented by X¹¹, the following group (HP1-b) and group (HP1-c) may be exemplified. * represents a bonding position with L¹¹.

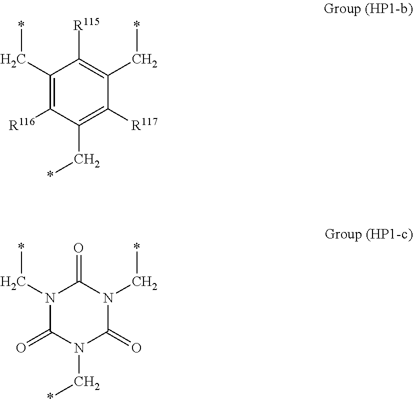

In the group (HP1-b), R¹¹⁵, R¹¹⁶, and R¹¹⁷ each independently represent a hydrogen atom or an alkyl group having 1 to 4 carbon atoms. The alkyl group having 1 to 4 carbon atoms is preferably a methyl group, an ethyl group, an n-propyl group, an isopropyl group, an n-butyl group, a sec-butyl group, an isobutyl group, or a tert-butyl group, is more preferably a methyl group or an ethyl group, and is still more preferably a methyl group.

As a tetravalent group represented by X¹¹, a group (alkane tetrayl group) obtained by removing four hydrogen atoms from an alkane having 1 to 6 carbon atoms (preferably an alkane having 1 to 4 carbon atoms) may be exemplified, and among them, methanetetrayl is preferable.

In a case where n is 2, 3, or 4, R¹¹ present in plural may be the same group or different group, R¹² present in plural may be the same group or different group, and L¹¹ present in plural may be the same group or different group.

Specific examples of the compound represented by Formula (HP1) include “Irganox 1010”, “Irganox 245”, and “Irganox 1076”, which are prepared by BASF, “ADK STAB AO-80”, “ADK STAB AO-60”, “ADK STAB AO-50”, “ADK STAB AO-40”, “ADK STAB AO-30”, “ADK STAB AO-20”, and “ADK STAB AO-330”, which are prepared by ADEKA CORPORATION, and “Sumilizer GA-80”, “Sumilizer GM”, and “Sumilizer GS” which are prepared by Sumitomo Chemical Company, Limited.

Examples of the hindered phenol compound include a compound represented by Formula (HP2).

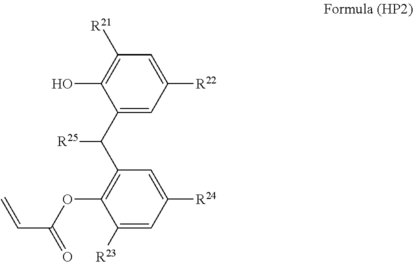

In Formula (HP2), R²¹, R²², R²³, R²⁴, and R²⁵ each independently represent a hydrogen atom or an alkyl group having 1 to 6 carbon atoms.

As the alkyl group having 1 to 6 carbon atoms represented by R²¹, an alkyl group having 4 to 6 carbon atoms is preferable, and an alkyl group having 4 or 5 carbon atoms is more preferable. As an alkyl group having 1 to 6 carbon atoms represented by R²¹ may be linear, branched, or cyclic, and is preferably a linear or branched alkyl group, and is more preferably a branched alkyl group.

As the alkyl group having 1 to 6 carbon atoms represented by R²¹, specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, and a 1,1-dimethyl butyl group are preferable, a tert-butyl group, a tert-pentyl group, or a 1,1-dimethyl butyl group is more preferable, and a tert-butyl group or a tert-pentyl group is still more preferable.

As the alkyl group having 1 to 6 carbon atoms represented by R²², an alkyl group having 1 to 5 carbon atoms is preferable, and an alkyl group having 1 to 4 carbon atoms is more preferable. As an alkyl group having 1 to 6 carbon atoms represented by R²² may be linear, branched, or cyclic, and is preferably a linear or branched alkyl group.

As the alkyl group having 1 to 6 carbon atoms represented by R²², specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, and a 1,1-dimethyl butyl group is preferable, and a methyl group, a tert-butyl group, or a tert-pentyl group is more preferable.

The specific forms and preferable forms of a group represented by R²³ are the same as those described for R²¹.

The specific forms and preferable forms of a group represented by R²⁴ are the same as those described for R²².

As the alkyl group having 1 to 6 carbon atoms represented by R²⁵, an alkyl group having 1 to 3 carbon atoms is preferable, and an alkyl group having 1 or 2 carbon atoms is more preferable. As an alkyl group having 1 to 6 carbon atoms represented by R²⁵ may be linear, branched, or cyclic, and is preferably a linear or branched alkyl group.

As the alkyl group having 1 to 6 carbon atoms represented by R²⁵, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, and a 1,1-dimethyl butyl group are preferable, a methyl group, an ethyl group, an n-propyl group or isopropyl group is more preferable, and a methyl group, an ethyl group are still more preferable.

As a group represented by R²¹, a tert-butyl group, or a tert-pentyl group is preferable.

As a group represented by R²², a methyl group, a tert-butyl group, or a tert-pentyl group is preferable.

As a group represented by R²³, a tert-butyl group, or a tert-pentyl group is preferable.

As a group represented by R²⁴, a methyl group, a tert-butyl group, or a tert-pentyl group is preferable.

As a group represented by R²⁵, a hydrogen atom, a methyl group, or an ethyl group is preferable.

Specific examples of the compound represented by Formula (HP2) include “Sumilizer GM” and “Sumilizer GS” prepared by Sumitomo Chemical Company, Limited.

### —Tocopherol Compound and Tocotrienol Compound—

Examples of a tocopherol compound or a tocotrienol compound include compounds represented by the following Formula (T1).

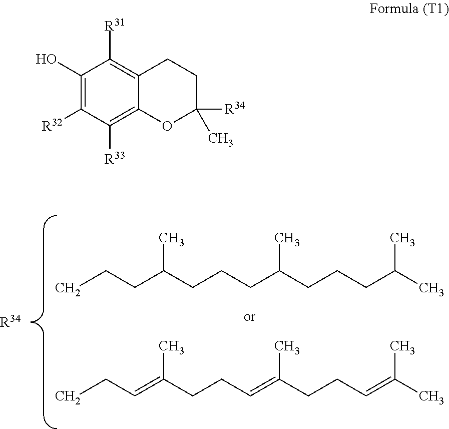

In Formula (T1), R³¹, R³², R³³ each independently represent a hydrogen atom or an alkyl group having 1 to 3 carbon atoms.

As an alkyl group having 1 to 3 carbon atoms represented by R³¹ may be linear, branched, or cyclic, and is preferably a linear or branched alkyl group.

As an alkyl group having 1 to 3 carbon atoms which is represented by R³¹, specifically, a methyl group, an ethyl group, an n-propyl group, and an isopropyl group are preferable, a methyl group or an ethyl group is more preferable, and a methyl group is still more preferable.

As the group represented by R³¹, a hydrogen atom or a methyl group is particularly preferable.

The specific forms and preferable forms of a group represented by R³² are the same as those described for R³¹.

The specific forms and preferable forms of a group represented by R³³ are the same as those described for R³¹.

Specific examples of the tocopherol compound include the following compounds.

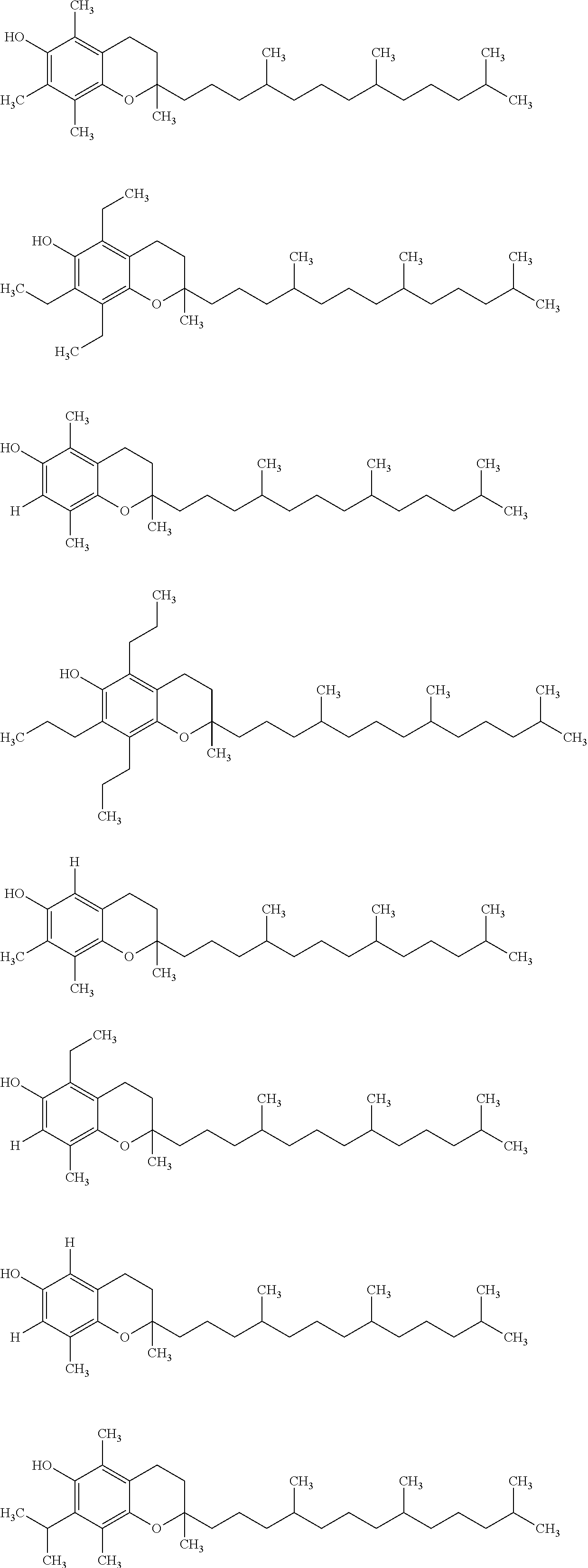

Specific examples of the tocotrienol compound include the following compounds.

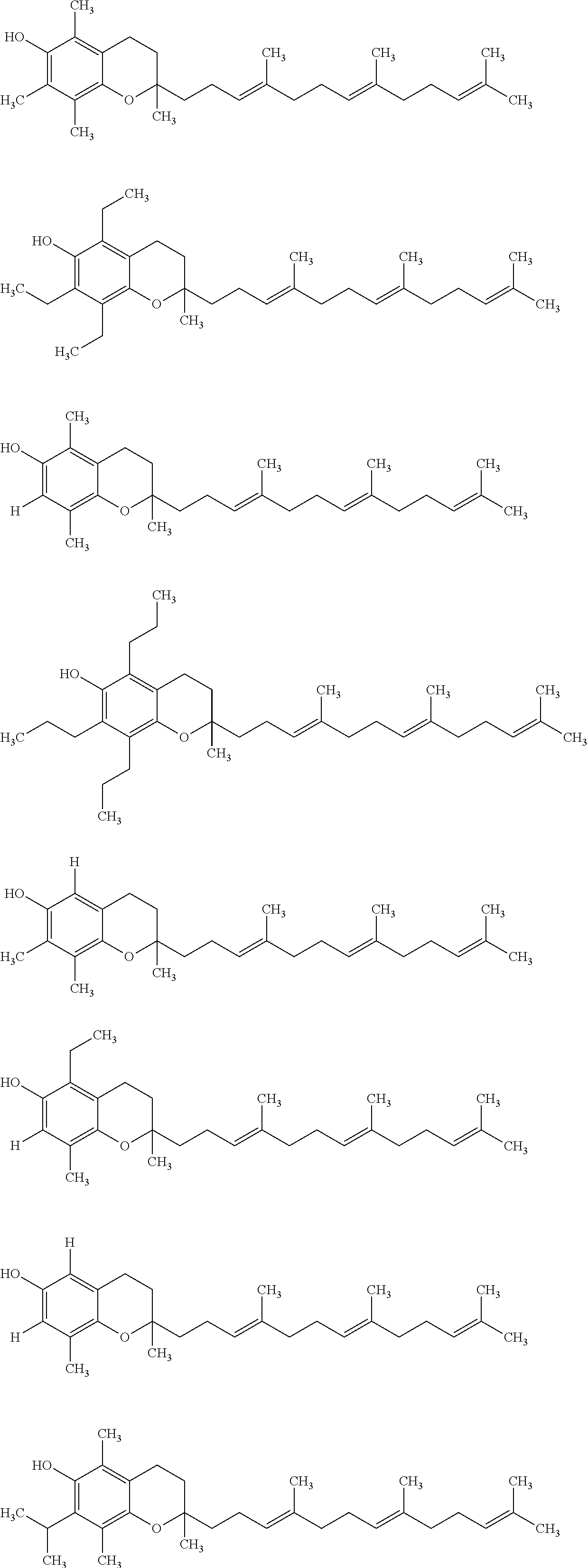

### —Phosphite Compound—

Examples of a phosphite compound include a compound represented by Formula (P1).

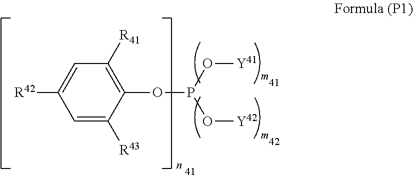

In Formula (P1), R⁴¹, R⁴², and R⁴³ each independently represent a hydrogen atom or an alkyl group having 1 to 12 carbon atoms, Y⁴¹ and Y⁴² each independently represent an aliphatic hydrocarbon group, n₄₁ represents 1, 2, or 3, m₄₁ represents 0 or 1, and m₄₂ represents 0 or 1. Here, n₄₁+m₄₁+m₄₂=3.

As the alkyl group having 1 to 12 carbon atoms represented by R⁴¹, an alkyl group having 1 to 10 carbon atoms is preferable, and an alkyl group having 1 to 9 carbon atoms is more preferable. As an alkyl group having 1 to 12 carbon atoms represented by R⁴¹ may be linear, branched, or cyclic, and is preferably a linear or branched alkyl group.

As an alkyl group having 1 to 12 carbon atoms represented by R⁴¹, specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group may be exemplified.

As an alkyl group having 1 to 12 carbon atoms represented by R⁴², the same forms as those of the alkyl group described for R⁴¹ may be exemplified.

As an alkyl group having 1 to 12 carbon atoms represented by R⁴³, the same forms as those described for R⁴¹ may be exemplified.

As a group represented by R⁴¹, a hydrogen atom, a methyl group or a tert-butyl group is preferable.

As the group represented by R⁴², an alkyl group having 1 to 9 carbon atoms is preferable, a methyl group or a tert-butyl group is more preferable, and a tert-butyl group is still more preferable.

As a group represented by R⁴³, a hydrogen atom, a methyl group or a tert-butyl group is preferable.

In a case where n₄₁ is 2 or 3, R⁴¹ present in plural may be the same group or different group, R⁴² present in plural may be the same group or different group, and R⁴³ present in plural may be the same group or different group.

In a case where n₄₁ is 2 or 3, R⁴¹ present in plural may be connected to each other to form a ring, R⁴³ present in plural may be connected to each other to form a ring, or R⁴¹ and R⁴³ may be connected to each other to form a ring.

The aliphatic hydrocarbon group represented by Y⁴¹ may be linear, branched, or may contain an alicyclic ring. From the viewpoint that a compound represented by Formula (P1) is likely to be dispersed in bioresin (A) and the viewpoint of the high dimensional accuracy, the group represented by Y⁴¹ is preferably an aliphatic hydrocarbon group not containing an alicyclic group (that is, a chain aliphatic hydrocarbon group), and is more preferably a linear aliphatic hydrocarbon group.

The aliphatic hydrocarbon group represented by Y⁴¹ may be a saturated aliphatic hydrocarbon group, and an unsaturated aliphatic hydrocarbon group. From the viewpoint that a compound represented by Formula (P1) is likely to be dispersed in bioresin (A) and the viewpoint of the high dimensional accuracy, the aliphatic hydrocarbon group represented by Y⁴¹ is preferably a saturated aliphatic hydrocarbon group.

From the viewpoint that a compound represented by Formula (P1) is likely to be dispersed in bioresin (A) and the viewpoint of the high dimensional accuracy, the number of carbon atoms of the aliphatic hydrocarbon group represented by Y⁴¹ is preferably from 1 to 20, and is more preferably from 1 to 12, and is still more preferably from 2 to 8.

The specific forms and preferable forms of an aliphatic hydrocarbon group represented by Y⁴² are the same as those described for Y⁴¹.

Hereinafter, specific examples of the aliphatic hydrocarbon group represented by Y⁴¹ and Y⁴² will be described below.

Y⁴¹, Y⁴²

| Linear and saturated | Linear and unsaturated | |
|---|---|---|
| —CH₃ | —CH═CH—CH₃ | —CH₂—CH═CH—CH₂CH₃ |
| —CH₂CH₃ | —CH═CH—C₅H₁₀CH₃ | —CH₂—CH═CH—C₄H₈CH₃ |
| —C₃H₆CH₃ | —CH═CH—C₉H₁₈CH₃ | —CH₂—CH═CH—C₈H₁₆CH₃ |
| —C₄H₈CH₃ | —CH═CH—C₁₃H₂₆CH₃ | —CH₂—CH═CH—C₁₆H₃₂CH₃ |
| —C₅H₁₀CH₃ | —CH═CH—C₁₇H₃₄CH₃ | —C₃H₆—CH═CH—C₇H₁₄CH₃ |
| —C₇H₁₄CH₃ | —CH₂—CH═CH₂ | —C₃H₆—CH═CH—C₁₄H₂₈CH₃ |
| —C₉H₁₈CH₃ | —C₆H₁₂—CH═CH₂ | —C₂H₄—CH═CH—C₂H₄CH₃ |
| —C₁₁H₂₂CH₃ | —C₁₀H₂₀—CH═CH₂ | —C₄H₈—CH═CH—C₄H₈CH₃ |
| —C₁₃H₂₆CH₃ | —C₁₄H₂₈—CH═CH₂ | —C₆H₁₂—CH═CH—C₆H₁₂CH₃ |
| —C₁₅H₃₀CH₃ | —C₁₈H₃₆—CH═CH₂ | —C₈H₁₆—CH═CH—C₈H₁₆CH₃ |

| | |
|---|---|
| —C₁₇H₃₄CH₃ | —CH₂—CH═CH—C₃H₆—CH═CH—C₃H₆CH₃ |
| —C₁₉H₃₈CH₃ | —CH₂—CH═CH—C₇H₁₄—CH═CH—C₇H₁₄CH₃ |

Y⁴¹, Y⁴²

| Branched and saturated | Branched and unsaturated |
|---|---|
| —CH(CH₃)₂ | —CH═CH—CH(CH₃)₂ |
| —C₄H₈—CH(CH₃)₂ | —CH═CH—C₃H₆—CH(CH₃)₂ |
| —C₉H₁₈—CH(CH₃)₂ | —CH═CH—C₉H₁₈—CH(CH₃)₂ |
| —C₁₄H₂₈—CH(CH₃)₂ | —CH═CH—C₁₅H₃₀—CH(CH₃)₂ |
| —C₁₇H₃₄—CH(CH₃)₂ | —CH═CH—C(CH₃)₃ |
| —C(CH₃)₃ | —CH═CH—C₃H₆—C(CH₃)₃ |
| —C₆H₁₂—C(CH₃)₃ | —CH═CH—C₈H₁₆—C(CH₃)₃ |
| —C₁₁H₂₂—C(CH₃)₃ | —CH═CH—C₁₄H₂₈—C(CH₃)₃ |
| —C₁₆H₃₂—C(CH₃)₃ | —CH═CH—CH(C₂H₅)₂ |
| —CH₂—CH(C₂H₅)₂ | —CH═CH—CH(C₆H₁₃)₂ |
| —CH₂—CH(C₆H₁₃)₂ | —CH═CH—CH(C₈H₁₇)₂ |
| —CH₂—CH(C₉H₁₉)₂ | —C₂H₄—CH═CH—C₃H₆—CH(CH₃)₂ |
| —CH(CH₃)—C₅H₁₀CH₃ | —C₃H₆—CH═CH—C₅H₁₀—CH(CH₃)₂ |
| —CH(CH₃)—C₁₂H₂₄CH₃ | —C₇H₁₄—CH═CH—C₇H₁₄—CH(CH₃)₂ |
| —CH(CH₃)—C₁₆H₃₂CH₃ | —CH(CH₃)—C₅H₁₀—CH═CH₂ |
| —CH(C₂H₅)—C₃H₆CH₃ | —CH(CH₃)—C₁₆H₃₂—CH═CH₂ |
| —CH(C₂H₅)—C₁₆H₃₂CH₃ | —C₄H₈—CH═CH—C₄H₈—CH═CH—C₄H₈—CH(CH₃)₂ |

n₄₁ represents 1, 2, or 3, is preferably 2 or 3, and is more preferably 3.

Specific examples of the compounds in a case where n₄₁=2 in Formula (P1) include “Irgafos 38” (bis(2,4-di-t-butyl-6-methylphenyl)-ethyl-phosphite) prepared by BASF.

In a case where n₄₁=3 in Formula (P1), the compound represented by Formula (P1) is a compound represented by Formula (P1-a).

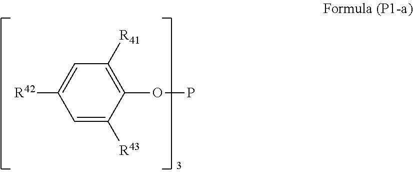

R⁴¹, R⁴², and R⁴³ in Formula (P1-a) are the same as R⁴¹, R⁴², R⁴³ in Formula (P1).

Specific examples of the compound represented by Formula (P1-a) include “Irgafos 168” prepared by BASF and “Irgafos TNPP” prepared by BASF.

Examples of a phosphite compound include a compound represented by Formula (P2).

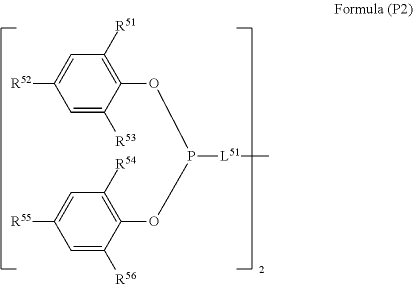

In Formula (P2), R⁵¹, R⁵², R⁵³, R⁵⁴, R⁵⁵, and R⁵⁶ each independently represent a hydrogen atom or an alkyl group having 1 to 12 carbon atoms, and L⁵¹ represents a single bond or a divalent linking group.

As the alkyl group having 1 to 12 carbon atoms represented by R⁵¹, an alkyl group having 1 to 10 carbon atoms is preferable, and an alkyl group having 1 to 9 carbon atoms is more preferable. As an alkyl group having 1 to 12 carbon atoms represented by R⁵¹ may be linear, branched, or cyclic, and is preferably a linear or branched alkyl group.

As an alkyl group having 1 to 12 carbon atoms represented by R⁵¹, specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group may be exemplified.

As an alkyl group having 1 to 12 carbon atoms represented by R⁵², the same forms as those described for R⁵¹ may be exemplified.

As an alkyl group having 1 to 12 carbon atoms represented by R⁵³, the same forms as those described for R⁵¹ may be exemplified.

As an alkyl group having 1 to 12 carbon atoms represented by R⁵⁴, the same forms as those described for R⁵¹ may be exemplified.

As an alkyl group having 1 to 12 carbon atoms represented by R⁵⁵, the same forms as those described for R⁵¹ may be exemplified.

As an alkyl group having 1 to 12 carbon atoms represented by R⁵⁶, the same forms as those described for R⁵¹ may be exemplified.

As a group represented by R⁵¹, a hydrogen atom, a methyl group or a tert-butyl group is preferable.

As the group represented by R⁵², an alkyl group having 1 to 9 carbon atoms is preferable, a methyl group or a tert-butyl group is more preferable, and a tert-butyl group is still more preferable.

As a group represented by R⁵³, a hydrogen atom, a methyl group or a tert-butyl group is preferable.

As a group represented by R⁵⁴, a hydrogen atom, a methyl group or a tert-butyl group is preferable.

As the group represented by R⁵⁵, an alkyl group having 1 to 9 carbon atoms is preferable, a methyl group or a tert-butyl group is more preferable, and a tert-butyl group is still more preferable.

As a group represented by R⁵⁶, a hydrogen atom, a methyl group or a tert-butyl group is preferable.

As a divalent linking group represented by L⁵¹, an alkylene group and an arylene group are exemplified, and an alkylene group having 1 to 6 carbon atoms or a phenylene group is preferable, and an alkylene group having 1 to 4 carbon atoms or a phenylene group is more preferable.

Specific examples of the compound represented by Formula (P2) include “Irgafos P-EPQ” prepared by BASF.

Examples of a phosphite compound include a compound represented by Formula (P3).

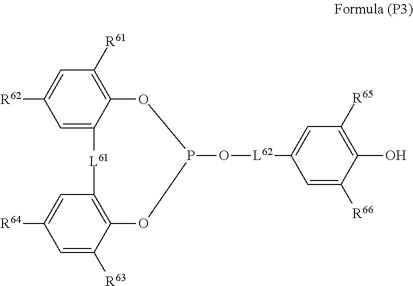

In Formula (P3), R⁶¹, R⁶², R⁶³, R⁶⁴, R⁶⁵, and R⁶⁶ each independently represent a hydrogen atom or an alkyl group having 1 to 12 carbon atoms, and L⁶¹ and L⁶² each independently represent a single bond or a divalent linking group.

As the alkyl group having 1 to 12 carbon atoms represented by R⁶¹, an alkyl group having 1 to 10 carbon atoms is preferable, and an alkyl group having 1 to 9 carbon atoms is more preferable. As an alkyl group having 1 to 12 carbon atoms represented by R⁶¹ may be linear, branched, or cyclic, and is preferably a linear or branched alkyl group.

As an alkyl group having 1 to 12 carbon atoms represented by R⁶¹, specifically, a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group may be exemplified.

As an alkyl group having 1 to 12 carbon atoms represented by R⁶², the same forms as those described for R⁶¹ may be exemplified.

As an alkyl group having 1 to 12 carbon atoms represented by R⁶³, the same forms as those described for R⁶¹ may be exemplified.

As an alkyl group having 1 to 12 carbon atoms represented by R⁶⁴, the same forms as those described for R⁶¹ may be exemplified.

As an alkyl group having 1 to 12 carbon atoms represented by R⁶⁵, the same forms as those described for^{R6′} may be exemplified.

As an alkyl group having 1 to 12 carbon atoms represented by R⁶⁶, the same forms as those described for^{R6′} may be exemplified.

As a group represented by R⁶¹, a hydrogen atom, a methyl group or a tert-butyl group is preferable.

As the group represented by R⁶², an alkyl group having 1 to 9 carbon atoms is preferable, a methyl group or a tert-butyl group is more preferable, and a tert-butyl group is still more preferable.

As a group represented by R⁶³, a hydrogen atom, a methyl group or a tert-butyl group is preferable.

As the group represented by R⁶⁴, an alkyl group having 1 to 9 carbon atoms is preferable, a methyl group or a tert-butyl group is more preferable, and a tert-butyl group is still more preferable.

As a group represented by R⁶⁵, a hydrogen atom, a methyl group, a tert-butyl group, or a tert-pentyl group is preferable.

As a group represented by R⁶⁶, a hydrogen atom, a methyl group, a tert-butyl group, or a tert-pentyl group is preferable.

At least one of R⁶⁵ and R⁶⁶ is preferably an alkyl group, and the alkyl group is preferably a tert-butyl group or a tert-pentyl group.

As a divalent linking group represented by L⁶¹, an alkylene group is exemplified, and an alkylene group having 1 to 3 carbon atoms is preferable, and an alkylene group having 1 or 2 carbon atoms is more preferable.

As L⁶¹, a single bond or a methylene group is particularly preferable.

As a divalent linking group represented by L⁶², an alkylene group and an arylene group are exemplified, and an alkylene group having 1 to 6 carbon atoms or a phenylene group is preferable, and an alkylene group having 1 to 4 carbon atoms or a phenylene group is more preferable.

Specific examples of the compound represented by Formula (P3) include “Sumilizer GP” prepared by Sumitomo Chemical Company, Limited.

—Hydroxylamine Compound—

A hydroxylamine compound in the exemplary embodiment is a compound having a structure in which at least one hydroxy group is directly bound to a nitrogen atom of an amine. As the hydroxylamine compound, N,N-dialkyl hydroxylamine is preferable.

Examples of the hydroxylamine compound include a compound represented by Formula (HA1).

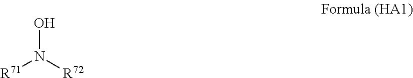

In Formula (HA1), R⁷¹ and R⁷² each independently represent an alkyl group having 14 to 20 carbon atoms.

As an alkyl group having 14 to 20 carbon atoms represented by R⁷¹, any one of a linear alkyl group, a branched alkyl group, and an alkyl group containing an alicyclic ring may be used, and a linear or branched alkyl group is preferable, and a linear alkyl group is more preferable.

In a case where the alkyl group having 14 to 20 carbon atoms represented by R⁷¹ is a branched alkyl group, the number of branched chains in the alkyl group is preferably from 1 to 3, is more preferably 1 or 2, and is still more preferably 1.

As the alkyl group having 14 to 20 carbon atoms represented by R⁷¹, a linear or branched alkyl group having 16 to 18 carbon atoms is preferable, and a linear alkyl group having 16 to 18 carbon atoms is particularly preferable.

The specific forms and preferable forms of a group represented by R⁷² are the same as those described for R⁷¹.

Hereinafter, specific examples of the alkyl group having 14 to 20 carbon atoms represented by R⁷¹ and R⁷² will be described.

R⁷¹, R⁷²

| Linear | Branched | |
|---|---|---|
| —C₁₃H₂₆CH₃ | —C₁₁H₂₂—CH(CH₃)₂ | —CH(CH₃)—C₁₁H₂₂CH₃ |
| —C₁₄H₂₈CH₃ | —C₁₃H₂₆—CH(CH₃)₂ | —CH(CH₃)—C₁₃H₂₆CH₃ |
| —C₁₅H₃₀CH₃ | —C₁₄H₂₈—CH(CH₃)₂ | —CH(CH₃)—C₁₄H₂₈CH₃ |
| —C₁₆H₃₂CH₃ | —C₁₅H₃₀—CH(CH₃)₂ | —CH(CH₃)—C₁₅H₃₀CH₃ |
| —C₁₇H₃₄CH₃ | —C₁₇H₃₄—CH(CH₃)₂ | —CH(CH₃)—C₁₇H₃₄CH₃ |
| —C₁₈H₃₆CH₃ | —C₁₀H₂₀—C(CH₃)₃ | —CH₂—CH(CH₃)—C₁₀H₂₀CH₃ |
| —C₁₉H₃₈CH₃ | —C₁₂H₂₄—C(CH₃)₃ | —CH₂—CH(CH₃)—C₁₂H₂₄CH₃ |
| | —C₁₄H₂₈—C(CH₃)₃ | —CH₂—CH(CH₃)—C₁₄H₂₈CH₃ |
| | —C₁₆H₃₂—C(CH₃)₃ | —CH₂—CH(CH₃)—C₁₆H₃₂CH₃ |

—C₃H₆—CH(CH₃)—C₃H₆—(CH(CH₃)—C₅H₁₀CH₃
—C₃H₆—CH(CH₃)—C₃H₆—(CH(CH₃)—C₇H₁₄CH₃

Specific examples of the compound represented by Formula (HA1) include “Irgastab FS-042” prepared by BASF.

Compound (C) may be used alone or two or more kinds thereof may be used in combination. A form in which two or more kinds thereof are used in combination may be any one of a form in which two or more kinds thereof are used in combination in the same group (for example, two or more kinds of a hindered phenol compound), and a form in which two or more kinds thereof are used in combination with other groups (for example, a hindered phenol compound and tocopherol compound).

A form in which at least one selected from the group consisting of a hindered phenol compound and a hydroxylamine compound and at least one selected from phosphite compounds are used in combination is preferable.

[Other Additives]

<<Thermoplastic Elastomer (D): Component (D)>>

The resin composition according to the exemplary embodiment may further contain thermoplastic elastomer (D).

Thermoplastic elastomer (D) is at least one thermoplastic elastomer selected from the group consisting of polymer (d1) with a core-shell structure having a core layer containing a butadiene polymer, and a shell layer containing a polymer selected from a styrene polymer and an acrylonitrile-styrene polymer on the surface of the core layer, polymer (d2) with a core-shell structure having a core layer and a shell layer containing a polymer of alkyl (meth)acrylate on the surface of the core layer, olefin polymer (d3) which is a polymer of α-olefin and alkyl (meth)acrylate, and contains 60% by weight or more of a constitutional unit derived from the α-olefin, styrene-ethylene-butadiene-styrene copolymer (d4), polyurethane (d5), and polyester (d6).

Thermoplastic elastomer (D) is, for example, a thermoplastic elastomer having elasticity at ordinary temperature (25° C.) and softening property at a high temperature similar to a thermoplastic resin.

(Polymer (d1) with a Core-Shell Structure: Component (d1))

Polymer (d1) with a core-shell structure is a polymer with a core-shell structure having a core layer and a shell layer on the surface of the core layer.

Polymer (d1) with a core-shell structure is a polymer having a core layer as an innermost layer and a shell layer as an outermost layer (specifically, a polymer obtained by graft polymerizing a styrene polymer or an acrylonitrile-styrene polymer to a core layer containing a butadiene polymer so as to form a shell layer).

One or more other layers (for example, 1 to 6 other layers) may be provided between the core layer and the shell layer. In a case of containing other layers, polymer (d1) with a core-shell structure is a polymer obtained by graft polymerizing plural kinds of polymers to a polymer to be a core layer to form a multilayered polymer.

The core layer containing a butadiene polymer is not particularly limited as long as it is a polymer obtained by polymerizing a component containing butadiene, and may be a core layer of a homopolymer of butadiene or may be a core layer of a copolymer of butadiene and other monomers. In a case where the core layer is a copolymer of butadiene and other monomers, examples of other monomers include vinyl aromatics. Among the vinyl aromatics, a styrene component (for example, styrene, alkyl-substituted styrene (for example, α-methyl styrene, 2-methyl styrene, 3-methyl styrene, 4-methyl styrene, 2-ethyl styrene, 3-ethyl styrene, and 4-ethyl styrene), and halogen-substituted styrene (for example, 2-chlorostyrene, 3-chlorostyrene, and 4-chlorostyrene)). The styrene component may be used alone or two or more kinds thereof may be used in combination. Among the styrene components, styrene is preferably used. As other monomers, multifunctional monomers such as allyl (meth) acrylate, triallyl isocyanurate, and divinyl benzene may be used.

Specifically, the core layer containing a butadiene polymer may be, for example, a homopolymer of butadiene, and may be a copolymer of butadiene and styrene, or it may be a terpolymer of butadiene, styrene and divinyl benzene.

In the butadiene polymer contained in the core layer, a ratio of a constitutional unit derived from butadiene is preferably from 60% by weight to 100% by weight (preferably, from 70% by weight to 100% by weight), and a ratio of a constitutional unit derived from the other monomers (preferably styrene component) is from 0% by weight to 40% by weight (preferably from 0% by weight to 30% by weight). For example, as a ratio of a constitutional unit derived from each monomer constituting the butadiene polymer, butadiene is from 60% by weight to 100% by weight, styrene is from 0% by weight to 40% by weight, and the content of divinyl benzene may be from 0% to 5% by weight with respect to the total amount of styrene and divinyl benzene.

The shell layer containing a styrene polymer is not particularly limited as long as the shell layer contains a polymer obtained by polymerizing a styrene component, and may be a shell layer of a homopolymer of styrene or a copolymer of styrene and other monomers. Examples of the styrene component include the same components as the styrene component exemplified for the core layer. Examples of other monomers include alkyl (meth)acrylate (for example, methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate). In the alkyl (meth)acrylate, at least a part of hydrogen of an alkyl chain may be substituted. Examples of the substituent include an amino group, a hydroxy group, and a halogen group. The alkyl (meth)acrylate may be used alone or two or more kinds thereof may be used in combination. As other monomers, multifunctional monomers such as allyl (meth) acrylate, triallyl isocyanurate, and divinyl benzene may be used. The styrene polymer contained in the shell layer may be a copolymer of a styrene component of 85% by weight to 100% by weight and other monomer components (preferably alkyl (meth)acrylate) of 0% by weight to 15% by weight.

Among them, the styrene polymer contained in the shell layer is preferably a copolymer of styrene and alkyl (meth)acrylate. From the same viewpoint, a copolymer of styrene and alkyl (meth)acrylate having an alkyl chain with 1 to 8 carbon atoms is preferable, and a polymer of alkyl (meth)acrylate having an alkyl chain with 1 to 4 carbon atoms is more preferable.

The shell layer containing an acrylonitrile-styrene polymer is a shell layer containing a copolymer of an acrylonitrile component and a styrene component. The acrylonitrile-styrene polymer is not particularly limited, and examples thereof include known acrylonitrile-styrene polymers. Examples of the acrylonitrile-styrene polymer include a copolymer of an acrylonitrile component of from 10% by weight to 80% by weight and a styrene component of from 20% by weight to 90% by weight. Examples of the styrene component copolymerized with the acrylonitrile component include the same components as the styrene component exemplified for the core layer. As the acrylonitrile-styrene polymer contained in the shell layer, multifunctional monomers such as allyl (meth) acrylate, triallyl isocyanurate, and divinyl benzene may be used.

Examples of one or more other layers provided between the core layer and the shell layer include a polymer layer described for the shell layer.

A weight ratio of the shell layer is preferably from 1% by weight to 40% by weight, is more preferably from 3% by weight to 30% by weight, and is still more preferably from 5% by weight to 15% by weight, with respect to the entire core-shell structure.

Among components (d1), examples of the commercially available product of polymer (d1) with a core-shell structure having a core layer containing a butadiene polymer, and a shell layer containing a styrene polymer on the core layer include “METABLEN” (registered trademark) prepared by Mitsubishi Chemical Corporation, “KANE ACE” (registered trademark) prepared by Kaneka Corporation, “Clearstrength” (registered trademark) prepared by Arkema, and “PARALOID” (registered trademark) prepared by Dow Chemical Japan Limited may be exemplified.

Among components (d1), examples of the commercially available product polymer (d1) with a core-shell structure having a core layer containing a butadiene polymer and a shell layer containing an acrylonitrile-styrene polymer on the surface of the core layer include “blendex” (registered trademark) prepared by Galata Chemicals, and “ELIX” prepared by ELIX POLYMERS.

(Polymer (d2) with a Core-Shell Structure: Component (d2))

Polymer (d2) with a core-shell structure is a polymer with a core-shell structure having a core layer and a shell layer on the surface of the core layer.

Polymer (d2) with a core-shell structure is a polymer having a core layer as an innermost layer and a shell layer as an outermost layer (specifically, a polymer in which a shell layer is obtained by graft polymerizing a polymer of alkyl (meth)acrylate to a polymer to be a core layer).

One or more other layers (for example, 1 to 6 other layers) may be provided between the core layer and the shell layer. In a case of containing other layers, polymer (d2) with a core-shell structure is a polymer obtained by graft polymerizing plural kinds of polymers to a polymer to be a core layer to form a multilayered polymer.

The core layer is not particularly limited, and may be a rubber layer. Examples of the rubber layer include a (meth)acrylic rubber layer, a silicone rubber layer, a styrene rubber layer, a conjugated diene rubber layer, an α-olefin rubber layer, a nitrile rubber layer, a urethane rubber layer, a polyester rubber layer, a polyamide rubber layer, and a copolymer rubber layer of two or more of these rubbers.

Among them, the rubber layer is preferably a (meth)acrylic rubber layer, a silicone rubber layer, a styrene rubber layer, a conjugated diene rubber layer, an α-olefin rubber layer, and a copolymer rubber layer of two or more of these rubbers.

The rubber layer may be a rubber layer obtained by copolymerizing and crosslinking a crosslinking agent (divinyl benzene, allyl acrylate, butylene glycol diacrylate, and the like).

Examples of the (meth)acrylic rubber include a polymer rubber obtained by polymerizing a (meth)acrylic component (an alkyl ester of (meth)acrylic acid having 2 to 8 carbon atoms and the like).

Examples of the silicone rubber include rubber made of a silicone component (polydimethyl siloxane, polyphenyl siloxane, and the like).

Examples of the styrene rubber include a polymer rubber obtained by polymerizing a styrene component (styrene, α-methyl styrene, and the like).

Examples of the conjugated diene rubber include a polymer rubber obtained by polymerizing a conjugated diene component (butadiene, isoprene, and the like).

Examples of the α-olefin rubber include a polymer rubber obtained by polymerizing an α-olefin component (ethylene, propylene, 2-methylpropylene).

Examples of the copolymer rubber include a copolymer rubber obtained by polymerizing two or more kinds of (meth) acrylic components, a copolymer rubber obtained by polymerizing a (meth) acrylic component and a silicone component, a copolymer rubber obtained by polymerizing a (meth) acrylic component, a conjugated diene, and a styrene component.

In the polymer constituting the shell layer, examples of alkyl (meth)acrylate include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate. In the alkyl (meth)acrylate, at least a part of hydrogen of an alkyl chain may be substituted. Examples of the substituent include an amino group, a hydroxy group, and a halogen group.

Among them, as a polymer of alkyl (meth)acrylate, a polymer of alkyl (meth)acrylate having an alkyl chain with 1 to 8 carbon atoms is preferable, a polymer of alkyl (meth)acrylate having an alkyl chain with 1 or 2 carbon atoms is more preferable, and a polymer of alkyl (meth)acrylate having an alkyl chain with 1 carbon atom still is more preferable.

The polymer constituting the shell layer may be a polymer obtained by polymerizing at least one selected from a glycidyl group-containing vinyl compound and unsaturated dicarboxylic anhydride in addition to the alkyl (meth)acrylate.

Examples of the glycidyl group-containing vinyl compound include glycidyl (meth) acrylate, glycidyl itaconate, diglycidyl itaconate, allyl glycidyl ether, styrene-4-glycidyl ether, and 4-glycidyl styrene.

Examples of the unsaturated dicarboxylic anhydride include maleic anhydride, itaconic anhydride, glutaconic anhydride, citraconic anhydride, and aconitic anhydride. Among them, maleic anhydride is preferable.

Examples of one or more other layers provided between the core layer and the shell layer include a polymer layer described for the shell layer.

A weight ratio of the shell layer is preferably from 1% by weight to 40% by weight, is more preferably from 3% by weight to 30% by weight, and is still more preferably from 5% by weight to 15% by weight, with respect to the entire core-shell structure.

Polymer (d2) having a core-shell structure may be prepared by a known method.

As a known method, an emulsion polymerization method may be exemplified. Specifically, the following methods are exemplified as a preparing method. First, a core particle (core layer) is prepared by emulsion polymerization of a mixture of monomers, and then a mixture of other monomers is subjected to emulsion polymerization in the presence of the core particle (core layer) to form a polymer having a core-shell structure in which a shell layer is formed around the core particle (core layer).

In a case of forming other layers between the core layer and the shell layer, the emulsion polymerization of a mixture of other monomers is repeated to obtain a polymer having a core-shell structure composed of a target core layer, other layers, and a shell layer.

Examples of the commercially available product of the polymer (d2) of core-shell structure include “METABLEN” (registered trademark) prepared by Mitsubishi Chemical Corporation, “KANE ACE” (registered trademark) prepared by Kaneka Corporation, “PARALOID” (registered trademark) prepared by Dow Chemical Japan Limited, “STAPHYLOID” (registered trademark) prepared by Aica Kogyo Company, Limited, and “PARAFACE” (registered trademark) prepared by KURARAY Co., Ltd.

An average primary particle diameter of polymer (d1) having a core-shell structure and polymer (d2) having a core-shell structure is not particularly limited, and it is preferably from 50 nm to 500 nm, is more preferably from 50 nm to 400 nm, is still more preferably from 100 nm to 300 nm, and is particularly preferably from 150 nm to 250 nm.

The average primary particle diameter means a value measured by the following method. The average primary particle diameter is a number average primary particle diameter which is an average of primary particle diameters over 100 particles. Each of the primary particle diameters is the maximum diameter in each primary particle and measured by observing the particles with a scanning electron microscope. Specifically, the average primary particle diameter is obtained by observing a dispersed form of the polymer having a core-shell structure in the resin composition with a scanning electron microscope.

(Olefin Polymer (d3): Component (d3))

Olefin polymer (d3) is a polymer of α-olefin and alkyl (meth)acrylate, and is preferably an olefin polymer containing 60% by weight or more of a constitutional unit derived from α-olefin.

In the olefin polymer, examples of the α-olefin include ethylene, propylene, and 2-methyl propylene. α-olefin having 2 to 8 carbon atoms is preferable, and α-olefin having 2 or 3 carbon atoms is more preferable. Among them, ethylene is still more preferable.

Examples of the alkyl (meth)acrylate polymerized with α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate. Alkyl (meth)acrylate having an alkyl chain with 1 to 8 carbon atoms is preferable, alkyl (meth)acrylate having an alkyl chain with 1 to 4 carbon atoms is more preferable, and alkyl (meth)acrylate having an alkyl chain with 1 or 2 carbon atom still is more preferable.

The olefin polymer is preferably a polymer of ethylene and methyl acrylate.

In the olefin polymer, the constitutional unit derived from α-olefin is preferably from 60% by weight to 97% by weight and is more preferably from 70% by weight to 85% by weight.

The olefin polymer may have other constitutional units in addition to the constitutional unit derived from α-olefin and the constitutional unit derived from alkyl (meth)acrylate. Here, other constitutional units may be 10% by weight or less with respect to the entire constitutional units in the olefin polymer.

(Styrene-Ethyl Ene-Butadiene-Styrene Copolymer (d4): Component (d4))

The copolymer (d4) is not particularly limited as long as it is a thermoplastic elastomer, and examples thereof include a known styrene-ethylene-butadiene-styrene copolymer. The copolymer (d4) may be a styrene-ethylene-butadiene-styrene copolymer and a hydrogenated product thereof.

The copolymer (d4) is preferably a styrene-ethylene-butadiene-styrene copolymer and a hydrogenated product thereof. Copolymer (d4) may be a block copolymer, for example, it is preferably a copolymer (triblock copolymer of styrene-ethylene/butylene-styrene) having a block of a styrene moiety at both ends and a block of a moiety containing a central ethylene/butylene by hydrogenating at least a part of a double bond of a butadiene moiety. The ethylene/butylene block moiety of the styrene-ethylene/butylene-styrene copolymer may be a random copolymer.

Copolymer (d4) is obtained by a known method. In a case where copolymer (d4) is the hydrogenated product of the styrene-ethylene-butadiene-styrene copolymer, for example, the copolymer is obtained by hydrogenating the butadiene moiety of a styrene-butadiene-styrene block copolymer in which the conjugated diene moiety is composed of 1,4 bonds.

Examples of the commercially available product of copolymer (d4) include “Kraton” (registered trademark) prepared by Kraton Corporation, and “Septon” (registered trademark) prepared by KURARAY Co., Ltd.

(Polyurethane (d5): Component (d5))

Polyurethane (d5) is not particularly limited as long as it is a thermoplastic elastomer, and examples thereof include known polyurethane. Polyurethane (d5) is preferably linear polyurethane. Polyurethane (d5) may be obtained, for example, by reacting a polyol component (polyether polyol, polyester polyol, polycarbonate polyol, or the like), an organic isocyanate component (aromatic diisocyanate, aliphatic (including alicyclic) diisocyanate, or the like), and if necessary, a chain extender (aliphatic (including alicyclic) diol, or the like). The polyol component may be used alone, or two or more kinds thereof may be used in combination and the organic isocyanate component may be used alone, or two or more kinds thereof may be used in combination.

Polyurethane (d5) is preferably aliphatic polyurethane. As aliphatic polyurethane, for example, aliphatic polyurethane obtained by reacting a polyol component containing polycarbonate polyol and an isocyanate component containing aliphatic diisocyanate is preferable.

Polyurethane (d5) may be obtained by reacting the polyol component and the organic isocyanate component so that a value of NCO/OH ratio in a raw material in the synthesis of polyurethane is in a range of 0.90 to 1.5, for example. Polyurethane (d5) is obtained by a known method such as a one shot method and a prepolymerization method.

Examples of the commercially available product of polyurethane (d5) include “Estane” (registered trademark) prepared by Lubrizol, and “Elastollan” (registered trademark) prepared by BASF. “Desmopan” (registered trademark) prepared by Bayer is exemplified.

(Polyester (d6): Component (d6))

Polyester (d6) is not particularly limited as long as it is a thermoplastic elastomer, and examples thereof include known polyester. Polyester (d6) is preferably aromatic polyester. In the exemplary embodiment, aromatic polyester represents polyester having an aromatic ring in its structure.

Examples of polyester (d6) include a polyester copolymer (polyether ester, polyester ester, or the like). Specific examples thereof include a polyester copolymer having a hard segment composed of a polyester unit and a soft segment composed of a polyester unit; a polyester copolymer having a hard segment composed of a polyester unit and a soft segment composed of a polyether unit; and a polyester copolymer having a hard segment composed of a polyester unit and a soft segment composed of a polyether unit and a polyester unit. A weight ratio of the hard segment and the soft segment of the polyester copolymer (hard segment/soft segment) may be, for example, from 20/80 to 80/20. The polyester unit constituting the hard segment and the polyester unit and polyether unit constituting the soft segment may be either aromatic or aliphatic (including alicyclic).

The polyester copolymer as polyester (d6) is obtained by using a known method. The polyester copolymer is preferably a linear polyester copolymer. The polyester copolymer is obtained by, for example, a method of esterifying or transesterifying a dicarboxylic acid component having 4 to 20 carbon atoms, a diol component having 2 to 20 carbon atoms, and a polyalkylene glycol component having the number average molecular weight of 300 to 20000 (including an alkylene oxide adduct of polyalkylene glycol), and a method of esterifying or transesterifying these components to prepare an oligomer and then polycondensating this oligomer. In addition, for example, a method of esterifying or transesterifying a dicarboxylic acid component having 4 to 20 carbon atoms, a diol component having 2 to 20 carbon atoms, and an aliphatic polyester component having the number average molecular weight of from 300 to 20000 may be exemplified. The dicarboxylic acid component is an aromatic or aliphatic dicarboxylic acid, or an ester derivative thereof, the diol component is aromatic or aliphatic diol, and the polyalkylene glycol component is aromatic or aliphatic polyalkylene glycol.

Among them, the dicarboxylic acid component of the polyester copolymer preferably uses a dicarboxylic acid component having an aromatic ring. Each of the diol component and polyalkylene glycol component preferably uses an aliphatic diol component and an aliphatic polyalkylene glycol component.

Examples of the commercially available product of polyester (d6) include “PELPRENE” (registered trademark) prepared by Toyobo Co., Ltd., “HYTREL” (registered trademark) prepared by Du Pont-Toray Co., Ltd.

<<Ester Compound (E): Component (E)>>

The resin composition according to the exemplary embodiment may further contain specific ester compound (E).

Specific ester compound (E) is at least one selected from the group consisting of a compound represented by Formula (1), a compound represented by Formula (2), a compound represented by Formula (3), a compound represented by Formula (4), and a compound represented by Formula (5).

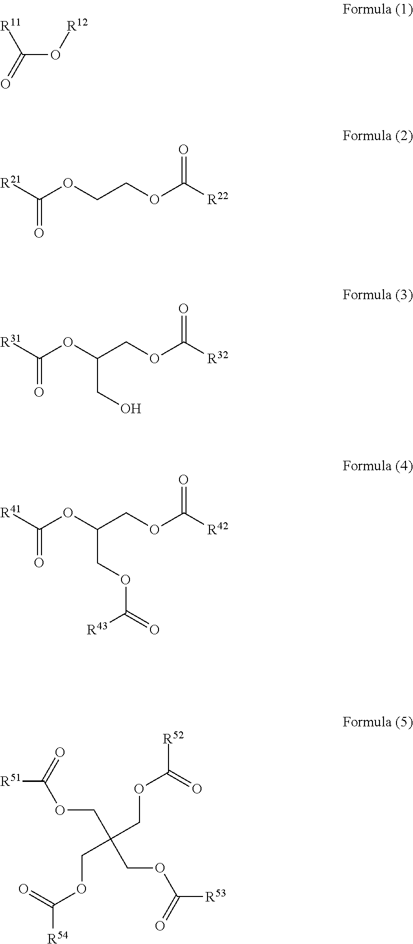

In Formula (1), R¹¹ represents an aliphatic hydrocarbon group having 7 to 28 carbon atoms and R¹² represents an aliphatic hydrocarbon group having 9 to 28 carbon atoms.

In Formula (2), R²¹ and R²² each independently represent an aliphatic hydrocarbon group having 7 to 28 carbon atoms.

In Formula (3), R³¹ and R³² each independently represent an aliphatic hydrocarbon group having 7 to 28 carbon atoms.

In Formula (4), R⁴¹, R⁴², and R⁴³ each independently represent an aliphatic hydrocarbon group having 7 to 28 carbon atoms.

In Formula (5), R⁵¹, R⁵², R⁵³, and R⁵⁴ each independently represent an aliphatic hydrocarbon group having 7 to 28 carbon atoms.

R¹¹ represents an aliphatic hydrocarbon group having 7 to 28 carbon atoms. The group represented by R¹¹ is preferably an aliphatic hydrocarbon group having 9 or more carbon atoms, is more preferably an aliphatic hydrocarbon group having 10 or more carbon atoms, and is still more preferably an aliphatic hydrocarbon group having 15 or more carbon atoms. The group represented by R¹¹ is preferably an aliphatic hydrocarbon group having 24 carbon atoms or less, is more preferably an aliphatic hydrocarbon group having 20 carbon atoms or less, and is still more preferably an aliphatic hydrocarbon group having 18 carbon atoms or less. The group represented by R¹¹ is particularly preferably an aliphatic hydrocarbon group having 17 carbon atoms.

The group represented by R¹¹ may be a saturated aliphatic hydrocarbon group, and an unsaturated aliphatic hydrocarbon group. A group represented by R¹¹ is preferable a saturated aliphatic hydrocarbon group.

The group represented by R¹¹ may be a linear aliphatic hydrocarbon group, a branched aliphatic hydrocarbon group, or an aliphatic hydrocarbon group containing alicyclic ring. The group represented by R¹¹ is preferably an aliphatic hydrocarbon group not containing an alicyclic group (that is, a chain aliphatic hydrocarbon group), and is more preferably a linear aliphatic hydrocarbon group.

In a case where the group represented by R¹¹ is an unsaturated aliphatic hydrocarbon group, the number of unsaturated bonds in the group represented by R¹¹ is preferably from 1 to 3, is more preferably 1 or 2, and is still more preferably 1.

In a case where the group represented by R¹¹ is an unsaturated aliphatic hydrocarbon group, the group represented by R¹¹ preferably contains a linear saturated hydrocarbon chain having 5 to 24 carbon atoms, more preferably contains a linear saturated hydrocarbon chain having 7 to 22 carbon atoms, and still more preferably contains a linear saturated hydrocarbon chain having 9 to 20 carbon atoms, and particularly preferably contains a linear saturated hydrocarbon chain having 15 to 18 carbon atoms.

In a case where the group represented by R¹¹ is a branched aliphatic hydrocarbon group, the number of branched chain in the group represented by R¹¹ is preferably from 1 to 3, is more preferably 1 or 2, and is still more preferably 1.

In a case where the group represented by R¹¹ is a branched aliphatic hydrocarbon group, the main chain of the group represented by R¹¹ preferably contains 5 to 24 carbon atoms, more preferably contains 7 to 22 carbon atoms, and still more preferably contains 9 to 20 carbon atoms, and particularly preferably contains 15 to 18 carbon atoms.

In a case where the group represented by R¹¹ is an aliphatic hydrocarbon group containing an alicyclic ring, the number of alicyclic rings in the group represented by R¹¹ is preferably 1 or 2, and is more preferably 1.

In a case where the group represented by R¹¹ is an aliphatic hydrocarbon group containing an alicyclic ring, the number of carbon atoms in the alicyclic ring in the group represented by R¹¹ is preferably 3 or 4, and is more preferably 3.

From the viewpoint of further improving the high dimensional accuracy of the resin molded article, the group represented by R¹¹ is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and is particularly preferably a linear saturated aliphatic hydrocarbon group. The preferable number of carbon atoms in these aliphatic hydrocarbon groups is as described above.

The group represented by R¹¹ may be a group in which a hydrogen atom in an aliphatic hydrocarbon group is substituted with a halogen atom (for example, a fluorine atom, a bromine atom, and an iodine atom), an oxygen atom, a nitrogen atom, and is preferably an unsubstituted group.

R¹² represents an aliphatic hydrocarbon group having 9 to 28 carbon atoms. As the group represented by R¹², the same forms as those described for R¹¹ may be exemplified. Here, the number of carbon atoms in the group represented by R¹² is preferably as follows.

The group represented by R¹² is preferably an aliphatic hydrocarbon group having 10 or more carbon atoms, is more preferably an aliphatic hydrocarbon group having 11 or more carbon atoms, and is still more preferably an aliphatic hydrocarbon group having 16 or more carbon atoms. The group represented by R¹² is preferably an aliphatic hydrocarbon group having 24 carbon atoms or less, is more preferably an aliphatic hydrocarbon group having 20 carbon atoms or less, and is still more preferably an aliphatic hydrocarbon group having 18 carbon atoms or less. The group represented by R¹² is particularly preferably an aliphatic hydrocarbon group having 18 carbon atoms.

From the viewpoint of further improving the high dimensional accuracy of the resin molded article, the group represented by R¹² is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and is particularly preferably a linear saturated aliphatic hydrocarbon group. The preferable number of carbon atoms in these aliphatic hydrocarbon groups is as described above.

The specific forms and preferable forms of the groups represented by R²¹, R²², R³¹, R³², R⁴¹, R⁴², R⁴³, R⁵¹, R⁵², R⁵³ and R⁵⁴ are the same as those described for R^{H}.

Hereinafter, specific examples of the aliphatic hydrocarbon group having 7 to 28 carbon atoms represented by R¹¹, R²¹, R²², R³¹, R³², R⁴¹, R⁴², R⁴³, R⁵¹, R⁵², R⁵³, and R⁵⁴, and specific examples of the aliphatic hydrocarbon group having 9 to 28 carbon atoms represented by R¹² will be described, but the exemplary embodiment is not limited thereto.

R¹¹, R¹², R²¹, R²², R³¹, R³², R⁴¹, R⁴², R⁴³, R⁵¹, R⁵², R⁵³, R⁵⁴
Linear and saturated

| | | |
|---|---|---|
| —C₆H₁₂CH₃ | —C₁₂H₂₄CH₃ | —C₁₉H₃₈CH₃ |
| —C₇H₁₄CH₃ | —C₁₄H₂₈CH₃ | —C₂₀H₄₀CH₃ |
| —C₈H₁₆CH₃ | —C₁₅H₃₀CH₃ | —C₂₁H₄₂CH₃ |
| —C₉H₁₈CH₃ | —C₁₆H₃₂CH₃ | —C₂₃H₄₆CH₃ |
| —C₁₀H₂₀CH₃ | —C₁₇H₃₄CH₃ | —C₂₅H₅₀CH₃ |
| —C₁₁H₂₂CH₃ | —C₁₈H₃₆CH₃ | —C₂₇H₅₄CH₃ |

R¹¹, R¹², R²¹, R²², R³¹, R³², R⁴¹, R⁴², R⁴³, R⁵¹, R⁵², R⁵³, R⁵⁴
Linear and unsaturated

| | |
|---|---|
| —CH═CH—C₄H₈CH₃ | —C₂H₄—CH═CH—C₂H₄CH₃ |
| —CH═CH—C₆H₁₂CH₃ | —C₄H₈—CH═CH—C₄H₈CH₃ |
| —CH═CH—C₈H₁₆CH₃ | —C₅H₁₀—CH═CH—C₁₀H₂₀CH₃ |
| —CH═CH—C₁₄H₂₈CH₃ | —C₆H₁₂—CH═CH—C₆H₁₂CH₃ |
| —CH═CH—C₁₅H₃₀CH₃ | —C₇H₁₄—CH═CH—C₃H₆CH₃ |
| —CH═CH—C₁₆H₃₂CH₃ | —C₇H₁₄—CH═CH—C₅H₁₀CH₃ |
| —CH═CH—C₁₇H₃₄CH₃ | —C₇H₁₄—CH═CH—C₇H₁₄CH₃ |
| —CH═CH—C₁₈H₃₆CH₃ | —C₇H₁₄—CH═CH—C₈H₁₆CH₃ |
| —CH═CH—C₂₀H₄₀CH₃ | —C₇H₁₄—CH═CH—C₉H₁₈CH₃ |
| —CH═CH—C₂₅H₅₀CH₃ | —C₈H₁₆—CH═CH—C₈H₁₆CH₃ |
| —C₅H₁₀—CH═CH₂ | —C₉H₁₈—CH═CH—C₅H₁₀CH₃ |
| —C₇H₁₄—CH═CH₂ | —C₉H₁₈—CH═CH—C₇H₁₄CH₃ |
| —C₁₅H₃₀—CH═CH₂ | —C₁₀H₂₀—CH═CH—C₁₂H₂₄CH₃ |
| —C₁₆H₃₂—CH═CH₂ | —C₁₀H₂₀—CH═CH—C₁₅H₃₀CH₃ |
| —C₁₇H₃₄—CH═CH₂ | —C₁₁H₂₂—CH═CH—C₇H₁₄CH₃ |
| —C₁₈H₃₆—CH═CH₂ | —C₁₂H₂₄—CH═CH—C₁₂H₂₄CH₃ |
| —C₂₁H₄₂—CH═CH₂ | —C₁₃H₂₆—CH═CH—C₇H₁₄CH₃ |
| —C₂₆H₅₂—CH═CH₂ | —CH₂—CH═CH—C₇H₁₄—CH═CH—C₇H₁₄CH₃ |
| —CH₂—CH═CH—C₃H₆CH₃ | —C₇H₁₄—CH═CH—CH₂—CH═CH—C₄H₈CH₃ |
| —CH₂—CH═CH—C₇H₁₄CH₃ | —C₇H₁₄—CH═CH—C₇H₁₄—CH═CH—C₇H₁₄CH₃ |
| —CH₂—CH═CH—C₁₀H₂₀CH₃ | —C₇H₁₄—CH═CH—C₉H₁₈—CH═CH—C₇H₁₄CH₃ |
| —CH₂—CH═CH—C₁₆H₃₂CH₃ | —C₇H₁₄—CH═CH—CH₂—CH═CH—CH₂—CH═CH—CH₂CH₃ |
| —CH₂—CH═CH—C₂₄H₄₈CH₃ | —CH═CH—C₇H₁₄—CH═CH—C₇H₁₄—CH═CH—C₇H₁₄CH₃ |

R¹¹, R¹², R²¹, R²², R³¹, R³², R⁴¹, R⁴², R⁴³, R⁵¹, R⁵², R⁵³, R⁵⁴
Branched and saturated

| | |
|---|---|
| —C₅H₁₀—CH(CH₃)₂ | —CH(C₂H₅)—C₇H₁₄CH₃ |
| —C₁₀H₂₀—CH(CH₃)₂ | —CH(C₂H₅)—C₁₄H₂₈CH₃ |
| —C₁₄H₂₈—CH(CH₃)₂ | —CH(C₂H₅)—C₁₆H₃₂CH₃ |
| —C₁₅H₃₀—CH(CH₃)₂ | —CH(C₂H₅)—C₁₈H₃₆CH₃ |
| —C₁₆H₃₂—CH(CH₃)₂ | —CH(C₄H₉)—C₁₅H₃₀CH₃ |
| —C₁₇H₃₄—CH(CH₃)₂ | —CH(C₆H₁₃)—C₁₂H₂₄CH₃ |
| —C₂₀H₄₀—CH(CH₃)₂ | —CH(C₆H₁₃)—C₁₄H₂₈CH₃ |
| —C₂₅H₅₀—CH(CH₃)₂ | —CH(C₆H₁₃)—C₁₆H₃₂CH₃ |
| —C₆H₁₂—C(CH₃)₃ | —CH₂—CH(CH₃)—C₃H₆CH₃ |
| —C₁₀H₂₀—C(CH₃)₃ | —CH₂—CH(CH₃)—C₆H₁₂CH₃ |
| —C₁₄H₂₈—C(CH₃)₃ | —CH₂—CH(CH₃)—C₈H₁₆CH₃ |
| —C₁₅H₃₀—C(CH₃)₃ | —CH₂—CH(CH₃)—C₁₂H₂₄CH₃ |
| —C₁₆H₃₂—C(CH₃)₃ | —CH₂—CH(CH₃)—C₁₆H₃₂CH₃ |
| —CH(CH₃)—C₅H₁₀CH₃ | —CH₂—CH(CH₃)—C₂₀H₄₀CH₃ |
| —CH(CH₃)—C₁₀H₂₀CH₃ | —CH₂—CH(CH₃)—C₂₄H₄₈CH₃ |
| —CH(CH₃)—C₁₃H₂₆CH₃ | —CH₂—CH(C₆H₁₃)₂ |
| —CH(CH₃)—C₁₄H₂₈CH₃ | —CH₂—CH(C₆H₁₃)—C₇H₁₄CH₃ |
| —CH(CH₃)—C₁₅H₃₀CH₃ | —CH₂—CH(C₆H₁₃)—C₉H₁₈CH₃ |
| —CH(CH₃)—C₁₆H₃₂CH₃ | —CH₂—CH(C₆H₁₃)—C₁₂H₂₄CH₃ |
| —CH(CH₃)—C₁₇H₃₄CH₃ | —CH₂—CH(C₆H₁₃)—C₁₅H₃₀CH₃ |
| —CH(CH₃)—C₁₈H₃₆CH₃ | —CH₂—CH(C₆H₁₃)—C₁₉H₃₈CH₃ |
| —CH(CH₃)—C₂₂H₄₄CH₃ | —CH₂—CH(C₈H₁₇)—C₉H₁₈CH₃ |
| —CH(CH₃)—C₂₅H₅₀CH₃ | —CH₂—CH(C₁₀H₂₁)—C₁₂H₂₄CH₃ |

—C₂H₄—CH(CH₃)—C₃H₆—CH(CH₃)—C₃H₆—CH(CH₃)—C₃H₆—CH(CH₃)₂

R¹¹, R¹², R²¹, R²², R³¹, R³², R⁴¹, R⁴², R⁴³, R⁵¹, R⁵², R⁵³, R⁵⁴
Branched and unsaturated

| | |
|---|---|
| —CH═CH—C₅H₁₀—CH(CH₃)₂ | —CH₂—CH═CH—CH(CH₃)—CH₂CH₃ |
| —CH═CH—C₁₂H₂₄—CH(CH₃)₂ | —CH₂—CH═CH—CH(CH₃)—C₃H₆CH₃ |
| —CH═CH—C₁₅H₃₀—CH(CH₃)₂ | —CH₂—CH═CH—CH(CH₃)—C₇H₁₄CH₃ |
| —CH═CH—C₁₆H₃₂—CH(CH₃)₂ | —CH₂—CH═CH—CH(CH₃)—C₁₆H₃₂CH₃ |
| —CH═CH—C₁₈H₃₆—CH(CH₃)₂ | —CH₂—CH═CH—CH(CH₃)—C₂₂H₄₄CH₃ |
| —CH═CH—C₂₃H₄₆—CH(CH₃)₂ | —CH₂—CH═CH—CH₂—CH(CH₃)—CH₂CH₃ |
| —CH═CH—C₇H₁₄—C(CH₃)₃ | —CH₂—CH═CH—C₂H₄—CH(CH₃)—C₂H₄CH₃ |
| —CH═CH—C₁₂H₂₄—C(CH₃)₃ | —CH₂—CH═CH—C₂H₄—CH(CH₃)—C₄H₈CH₃ |
| —CH═CH—C₁₄H₂₈—C(CH₃)₃ | —CH₂—CH═CH—C₆H₁₂—CH(CH₃)—C₆H₁₂CH₃ |
| —CH═CH—C₁₆H₃₂—C(CH₃)₃ | —CH₂—CH═CH—C₇H₁₄—CH(CH₃)—C₇H₁₄CH₃ |
| —CH═CH—C₂₀H₄₀—C(CH₃)₃ | —CH₂—CH═CH—C₇H₁₄—CH(CH₃)—C₈H₁₆CH₃ |
| —CH═CH—CH(C₈H₁₇)₂ | —CH₂—CH═CH—CH₂—CH═CH—CH(CH₃)—C₃H₆CH₃ |
| —CH═CH—CH(C₆H₁₃)—C₇H₁₄CH₃ | —CH₂—CH═CH—CH₂—CH═CH—CH(CH₃)—C₇H₁₄CH₃ |
| —CH═CH—CH(C₆H₁₃)—C₁₁H₂₂CH₃ | —CH₂—CH═CH—CH₂—CH═CH—CH(CH₃)—C₁₆H₃₂CH₃ |
| —CH═CH—CH(C₈H₁₇)—C₉H₁₈CH₃ | —CH₂—CH═CH—CH(CH₃)—CH═CH—CH₂—C₃H₆CH₃ |
| —CH═CH—CH(C₈H₁₇)—C₁₂H₂₄CH₃ | —CH₂—CH═CH—CH(CH₃)—CH═CH—CH₂—C₇H₁₄CH₃ |
| —C₃H₆—CH═CH—C₅H₁₀—CH(CH₃)₂ | —CH₂—CH═CH—CH(C₂H₅)—CH═CH—CH₂—C₇H₁₄CH₃ |
| —C₇H₁₄—CH═CH—C₆H₁₂—CH(CH₃)₂ | —CH₂—CH═CH—CH(CH₃)—CH═CH—CH₂—C₁₆H₃₂CH₃ |
| —C₇H₁₄—CH═CH—C₇H₁₄—CH(CH₃)₂ | —CH₂—CH═CH—CH(C₂H₅)—CH═CH—CH₂—C₁₆H₃₂CH₃ |
| —C₈H₁₆—CH═CH—C₆H₁₂—CH(CH₃)₂ | —CH₂—CH═CH—CH(CH₃)—CH═CH—CH₂—C₁₉H₃₈CH₃ |
| —C₈H₁₆—CH═CH—C₇H₁₄—CH(CH₃)₂ | —CH₂—CH═CH—CH(CH₃)—CH═CH—CH(CH₃)—CH₂CH₃ |
| —CH(CH₃)—C₁₄H₂₈—CH═CH₂ | —CH₂—CH═CH—CH(CH₃)—CH═CH—CH(CH₃)—C₃H₆CH₃ |
| —CH(CH₃)—C₁₆H₃₂—CH═CH₂ | —CH₂—CH═CH—CH(CH₃)—CH═CH—CH(CH₃)—C₇H₁₄CH₃ |
| —CH(C₂H₅)—C₁₄H₂₈—CH═CH₂ | —CH₂—CH═CH—CH(C₂H₅)—CH═CH—CH(C₂H₅)—C₇H₁₄CH₃ |
| —CH(C₂H₅)—C₁₆H₃₂—CH═CH₂ | —CH₂—CH═CH—CH(CH₃)—CH═CH—CH(CH₃)—C₁₂H₂₄CH₃ |
| —CH(C₄H₉)—C₁₄H₂₈—CH═CH₂ | —CH₂—CH═CH—CH(CH₃)—CH═CH—CH(CH₃)—C₁₅H₃₀CH₃ |
| —CH(C₆H₁₃)—C₁₀H₂₀—CH═CH₂ | —CH₂—CH═CH—CH(CH₃)—CH═CH—CH(CH₃)—C₁₈H₃₆CH₃ |
| —CH(C₆H₁₃)—C₁₂H₂₄—CH═CH₂ | —C₄H₈—CH═CH—C₄H₈—CH═CH—C₄H₈—CH(CH₃)₂ |
| —CH₂—CH(C₆H₁₃)—C₇H₁₄—CH═CH₂ | —C₇H₁₄—CH═CH—C₇H₁₄—CH═CH—C₇H₁₄—CH(CH₃)₂ |

Ester compound (E) may be used alone or two or more kinds thereof may be used in combination.

### [Content or Weight Ratio of Components (A) to (E)]

A content or weight ratio of each component will be described. From the viewpoint of increasing the dimensional accuracy of the resin molded article, the content or weight ratio of each component is preferably in the following range. Note that, the abbreviation of each component is as follows.

Component (A)=resin (A) having a biomass-derived carbon atom

Component (B)=plasticizer (B)

Component (C)=compound (F) of at least one selected from the group consisting of a hindered phenol compound, a tocopherol compound, a tocotrienol compound, a phosphite compound, and a hydroxylamine compound

A content of component (A) in the resin composition according to the exemplary embodiment is preferably from 50% by weight or more, is more preferably from 60% by weight or more, and is still more preferably from 70% by weight or more, with respect to the entire weight of the resin composition.

A content of component (B) in the resin composition according to the exemplary embodiment is preferably from 1% by weight to 25% by weight, is more preferably from 3% by weight to 20% by weight, and is still more preferably from 5% by weight to 15% by weight, with respect to the entire weight of the resin composition.

A content of component (C) in the resin composition according to the exemplary embodiment is preferably from 0.01% by weight to 5% by weight, is more preferably from 0.05% by weight to 2% by weight, and is still more preferably from 0.1% by weight to 1% by weight, with respect to the entire weight of the resin composition.

A content ratio (B/A) of component (B) to component (A) is preferably 0.03≤(B/A)≤0.3, is more preferably 0.05≤(B/A)≤0.2, and is still more preferably 0.07≤(B/A)≤0.15.

A ratio of component (C) to the total amount of component (A), component (B), and component (C) is preferably from 0.05% by weight to 5% by weight, is more preferably from 0.1% by weight to 5% by weight, and is till more preferably from 0.1% by weight to 1% by weight.

A content or weight ratio of other additives is preferably in the following range. Note that, the abbreviation of each component is as follows.

Component (D)=thermoplastic elastomer (D)

Component (E)=ester compound (E)

A content of component (D) in the resin composition according to the exemplary embodiment is preferably from 1% by weight to 20% by weight, is more preferably from 3% by weight to 15% by weight, and is still more preferably from 5% by weight to 10% by weight, with respect to the entire weight of the resin composition.

A content ratio (D/A) of component (D) to component (A) is preferably 0.025≤(D/A)≤0.3, is more preferably 0.05≤(D/A)≤0.2, and is still more preferably 0.06≤(D/A)≤0.15.

A content of component (E) in the resin composition according to the exemplary embodiment is preferably from 0.1% by weight to 15% by weight, is more preferably from 0.5% by weight to 10% by weight, and is still more preferably from 1% by weight to 5% by weight, with respect to the entire weight of the resin composition.

A content ratio (E/A) of component (E) to component (A) is preferably 0.0025≤(E/A)≤0.1, is more preferably 0.003≤(E/A)≤0.095, and is still more preferably 0.005≤(E/A)≤0.05.

[Other Components]

The resin composition according to the exemplary embodiment may contain other components.

Examples of other components include a flame retardant, a compatibilizer, an antioxidant, a release agent, a light fastness agent, a weathering agent, a colorant, a pigment, a modifier, a drip inhibitor, an antistatic agent, a hydrolysis inhibitor, a filler, and a reinforcing agent (glass fiber, carbon fiber, talc, clay, mica, glass flake, milled glass, glass beads, crystalline silica, alumina, silicon nitride, aluminum nitride, boron nitride, and the like).

In addition, if necessary, components (additives) such as an acid acceptor and a reactive trapping agent for preventing release of acetic acid may be added. Examples of the acid acceptor include oxides such as magnesium oxide and aluminum oxide; metal hydroxides such as magnesium hydroxide, calcium hydroxide, aluminum hydroxide, and hydrotalcite; calcium carbonate; and talc.

Examples of the reactive trapping agent include an epoxy compound, an acid anhydride compound, and a carbodiimide.

The content of these other components is preferably 0% by weight to 5% by weight with respect to the entire amount of the resin composition. Here, “0% by weight” means not containing other components in the resin composition.

The resin composition according to the exemplary embodiment may contain other resins than the resin (bioresin (A) and the like). However, in a case of containing other resins, the content of other resins may be from 5% by weight or less and is more preferably from 1% by weight or less, with respect to the total amount of the resin composition. It is more preferably not to contain other resins in the resin composition (that is, 0% by weight).

Examples of other resins include thermoplastic resins in the related art, and specific examples thereof include a polycarbonate resin; a polypropylene resin; a polyester resin; a polyolefin resin; a polyester carbonate resin; a polyphenylene ether resin; a polyphenylene sulfide resin; a polysulfone resin; a polyether sulfone resin; a polyarylene resin; a polyetherimide resin; a polyacetal resin; a polyvinyl acetal resin; a polyketone resin; a polyether ketone resin; a polyetheretherketone resin; a polyaryl ketone resin; a polyether nitrile resin; a liquid crystal resin; a polybenzimidazole resin; a polyparabanic acid resin; a vinyl polymer or copolymer obtained by polymerization or copolymerization of one or more vinyl monomers selected from the group consisting of aromatic alkenyl compounds, methacrylic acid esters, acrylic acid esters, and vinyl cyanide compounds; a diene-aromatic alkenyl compound copolymer; a vinyl cyanide-diene-aromatic alkenyl compound copolymer; an aromatic alkenyl compound-diene-vinyl cyanide-N-phenyl maleimide copolymer; a vinyl cyanide-(ethylene-diene-propylene (EPDM))-aromatic alkenyl compound copolymer; a vinyl chloride resin; and a chlorinated vinyl chloride resin. The resins may be used alone or two or more kinds thereof may be used in combination.

[Method of Preparing a Resin Composition]

The resin composition according to the exemplary embodiment is prepared by molten-kneading a mixture containing, for example, bioresin (A), and if necessary, plasticizer (B), compound (C), other additives (thermoplastic elastomer (D), ester compound (E)), and other component. Besides, the resin composition according to the exemplary embodiment is also prepared, for example, by dissolving the above components in a solvent.

Examples of units for molten-kneading include known units such as a twin-screw extruder, a HENSCHEL MIXER, a BANBURY MIXER, a single screw extruder, a multi-screw extruder, and a co-kneader.

<Resin Molded Article>

The resin molded article according to the exemplary embodiment contains a resin composition according to the exemplary embodiment. That is, the resin molded article according to the exemplary embodiment has the same composition as that of the resin composition according to the exemplary embodiment.

From the viewpoint of high degree of freedom of shape, injection molding is preferable as the method of molding the resin molded article according to the exemplary embodiment. In this respect, the resin molded article is preferably an injection molded article obtained by injection molding.

The cylinder temperature of injection molding is, for example, from 160° C. to 280° C., and is preferably from 180° C. to 260° C. The mold temperature of injection molding is, for example, from 40° C. to 90° C., and is preferably from 60° C. to 80° C.

The injection molding may be performed by using a commercially available apparatus such as NEX500 Nissei Plastic Industrial Co., Ltd., NEX150 Nissei Plastic Industrial Co., Ltd., NEX7000 manufactured by Nissei Plastic Industrial Co., Ltd., PNX40 manufactured by Nissei Plastic Industrial Co., Ltd., and SE50D manufactured by Sumitomo Heavy Industries, Ltd.

The molding method for obtaining the resin molded article according to the exemplary embodiment is not limited to the above-described injection molding, and for example, extrusion molding, blow molding, hot press molding, calender molding, coating molding, cast molding, dipping molding, vacuum molding, transfer molding and the like may be applied.

The resin molded article according to the exemplary embodiment is suitably used for applications such as electronic and electrical equipment, office equipment, household electric appliances, automotive interior materials, toys, containers, carriers, adsorbents, and separation membrane. More specifically, a housing of electronic and electrical equipment or a household electrical appliance; various parts of an electronic and electrical equipment or a home electric appliance; an interior component of a car; a block assembly toy; a plastic model kit; a storage case of CD-ROM, DVD or the like; a dishware; a beverage bottle; a food tray; a wrapping material; a film; a sheet; a catalyst carrier; a water absorbing material; and a humidity adjusting material.

### Examples

Hereinafter, the present invention will be described in more detail with reference to examples, but the present invention is not limited to these examples. Unless otherwise specified, “part” represents “part by weight”.

<Preparation of Each Material>

The following materials are prepared.

(Preparation of Bioresin (A))
CA1: “CAP482-20” prepared by Eastman Chemical Company, cellulose acetate propionate, weight average degree of polymerization: 716, degree of acetyl group substitution: 0.18, degree of propionyl group substitution: 2.49
CA2: “CAP482-0.5” prepared by Eastman Chemical Company, cellulose acetate propionate, weight average degree of polymerization: 189, degree of acetyl group substitution: 0.18, degree of propionyl group substitution: 2.49
CA3: “CAP504-0.2” prepared by Eastman Chemical Company, cellulose acetate propionate, weight average degree of polymerization: 133, degree of acetyl group substitution: 0.04, degree of propionyl group substitution: 2.09
CA4: “CAB171-15” prepared by Eastman Chemical Company, cellulose acetate butyrate, weight average degree of polymerization: 754, degree of acetyl group substitution: 2.07, degree of butyryl group substitution: 0.73
CA7: “L-50” prepared by Daicel Corporation, diacetyl cellulose, weight average degree of polymerization: 570
CA8 “LT-35” prepared by Daicel Corporation, triacetyl cellulose, weight average degree of polymerization: 385
RC1: “Tenite propionate 360A4000012” prepared by Eastman Chemical Company, cellulose acetate propionate, weight average degree of polymerization: 716, degree of acetyl group substitution: 0.18, degree of propionyl group substitution: 2.49.

The above products contain “dioctyl adipate (DOA)” (corresponding to component (B)), and cellulose acetate propionate is 88% by weight and dioctyl adipate is 12% by weight.
RC2: “Treva GC6021” prepared by Eastman Chemical Company, cellulose acetate propionate, weight average degree of polymerization: 716, degree of acetyl group substitution: 0.18, degree of propionyl group substitution: 2.49.

The above products contain a chemical substance corresponding to component (D), and the content thereof is from 3% by weight to 10% by weight.
PE1: “Ingeo3001D” prepared by Nature Works LLC, Polylactic acid
PE2: “Braskem SGF4950” prepared by Braskem S. A, bio-derived polyethylene
PA1: “Rilsan BMNO” prepared by ARKEMA, polyamide 11
PE3: “AONILEX X151A” prepared by Kaneka Corporation, bio-polyester

CA1 satisfies the following (2), (3), and (4). CA2 satisfies the following (4). (2) When measurement is performed by a GPC method with tetrahydrofuran as a solvent, a weight average molecular weight (Mw) in terms of polystyrene is 160,000 to 250,000, a ratio Mn/Mz of number average molecular weight (Mn) in terms of polystyrene to Z-average molecular weight (Mz) in terms of polystyrene is from 0.14 to 0.21, and a ratio Mw/Mz of a weight average molecular weight (Mw) in terms of polystyrene to Z-average molecular weight (Mz) in terms of polystyrene is from 0.3 to 0.7. (3) When measurement is performed with capillograph at 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is from 0.1 to 0.3. (4) When a small square plate test piece (D11 test piece specified by JIS K7139:2009, 60 mm×60 mm, thickness of 1 mm) obtained by injection molding of CAP is kept for 48 hours in an atmosphere at a temperature of 65° C. and a relative humidity of 85%, both an expansion coefficient in a MD direction and an expansion coefficient in a TD direction are from 0.4% to 0.6%.

(Preparation of Other Resins)
PM1: “DELPET 720V” prepared by Asahi Kasei Corporation, polymethyl methacrylate (PMMA)

(Preparation of Plasticizer (B))
PL1: “NX-2026” prepared by Cardolite, cardanol, molecular weight=298 to 305
PL4: “Ultra LITE 513” prepared by Cardolite, glycidyl ether of cardanol, molecular weight=354 to 361
PL6: “Daifatty 101” prepared by Daihachi Chemical Industry Co., Ltd., adipic acid ester-containing compound, molecular weight of adipic acid ester=326 to 378
PL7: “DOA” prepared by Mitsubishi Chemical Corporation, dioctyl adipate, molecular weight of 371

(Preparation of Mixture Stabilizer (C))
ST1: “Irganox B225” prepared by BASF, a mixture of tetrakis[3-(3′,5′-di-t-butyl-4′-hydroxyphenyl) propionic acid] pentaerythritol and tris(2,4-di-t-butylphenyl) phosphite

(Preparation of Other Additives)
ELL “METABLEN W-600A” prepared by Mitsubishi Chemical Corporation, a polymer with a core-shell structure (polymer in which a shell layer is obtained by graft polymerizing a “homopolymer rubber of methyl methacrylate and 2-ethylhexyl acrylate” to a “copolymer rubber of 2-ethylhexyl acrylate and n-butyl acrylate” corresponding to a core layer), average primary particle diameter=200 nm
EL5: “Kane Ace B-564” prepared by KANEKA CORPORATION, methyl methacrylate-butadiene-styrene copolymerization (MBS) resin, polymer (d1) with core-shell structure
LU1: “STEARYL STEARATE” prepared by FUJIFILM Wako Pure Chemical Corporation, stearyl stearate (a compound represented by Formula (1), the number of carbon atoms of R¹¹: 17, the number of carbon atoms of R¹²: 18)

### <Examples 1 to 21, Comparative Examples 1 to 5> (Kneading and Injection Molding)

Kneading is carried out in a twin-screw kneader (manufactured by labtech engineering, LTE 20-44) at a charge composition ratio indicated in Table 1 and at a kneading temperature (cylinder temperature) indicated in Table 1 so as to obtain a resin composition (pellet).

With the obtained pellets, the resin molded articles of (1) and (2) are molded respectively by using an injection molding machine (NEX 500I, manufactured by Nissei Plastic Industrial Co., Ltd.) under the conditions of an injection peak pressure which does not exceed 180 MPa, and at the molding temperature (cylinder temperature) and mold temperature indicated in Table 1. In the molding of (2), a test piece in which the holding pressure is changed 10 MPa increments from 10 MPa to 120 MPa is manufactured.
(1): Strip-shaped test piece (width of 13 mm, length of 50 mm, and thickness of 2 mm)
(2): Small square plate test piece (type of D12, 60 mm×60 mm, and thickness of 2 mm)

<Measurement of Content of Biomass-Derived Carbon Atom>

With the obtained resin composition in the pellet shape, the abundance of ¹⁴C in the entire carbon atoms in the resin composition is measured based on the regulation of ASTM D 6866:2012, and the content of biomass-derived carbon atom is calculated. It is indicated in the field of “the content of biomass-derived carbon atom” in Table 2.

<Measurement of Dynamic Viscoelasticity>

Measurement is carried out on the basis of “FIG. 1a) Test method using fixed support test piece” in “Plastics—Determination of dynamic. mechanical properties-. Part 5: Flexural vibration.—Non-resonance method” based on JIS K7244-5:1999.

The manufactured strip test piece is used and a bifurcated bending method with a dynamic viscoelasticity measurement device (DMS 6100, manufactured by Hitachi High-Technologies Corporation.) is used. On the basis of “FIG. 1a) Test method using fixed support test piece” in “Plastics—Determination of dynamic. mechanical properties—. Part 5: Flexural vibration.—Non-resonance method” based on JIS K7244-5:1999, a measurement is performed under the conditions of raising the temperature from 10° C. to the highest attainable temperature (set within the range of 100° C. to 180° C.) at a heating rate of 2° C./min under sinusoidal vibration, measurement frequency of 1 Hz, and nitrogen flow. The values at the temperatures of 25° C., 80° C., and 90° C. are confirmed from each curves of the obtained storage modulus and loss modulus so as to obtain the above-described storage modulus E′f and loss modulus E″f.

<Evaluation>

The resin molded article obtained is subjected to the following evaluation. The evaluation results are indicated in Table 2.

(Measurement and Evaluation of Mold Shrinkage Rate)

The manufactured type D12 small square plate test piece is allowed to stand at 23° C. at 50% RH for 24 hours or longer after molding, and the length of the four sides of the square plate test piece is measured with a measuring microscope (MM-400/T manufactured by Nikon Corporation), an average value of MD (flow direction, that is, a length direction of a cavity of a mold used for injection molding) and TD (direction orthogonal to MD) is calculated, and a mold shrinkage rate of MD and TD is calculated according to ISO 294-4:2001.

For each example and comparative example, a minimum holding pressure at which an average mold shrinkage rate of MD and TD is 0.4% or less is obtained, and “appearance evaluation of test piece” and “measurement of warpage” are performed for the test piece at the minimum holding pressure.

In a case where a molding shrinkage rate is not reduced to 0.4% or less, and those having overpacks (burrs (sheet-like)), the molding shrinkage rate are evaluated as “F”.

(Appearance Evaluation of Test Piece (Burr Over Pack))

The presence or absence of “burr” of the manufactured type D12 small square plate test piece is visually evaluated.

None: No burr occurred

Burr (thread-like): In a case where a leaked resin is thread-like

Burr (sheet-like): In a case where a resin is sheet-like

(Measurement of Warp)

The type D12 small square plate test piece is placed on an aluminum plate in which a constant temperature and constant humidity tank (manufactured by ESPEC, ARL-1100-J) is set at 65° C./85% rh and kept for 24 hours, the distance between a surface of the aluminum plate and the most distant part of an end of the test piece is measured with a vernier caliper at the point where the end of the D12 small square plate test piece is most distant from the aluminum plate, and a warp deformation amount (mm) is obtained.

TABLE 1

| | | | | | | | | | | Component | |
|---|---|---|---|---|---|---|---|---|---|---|---|
| | | | | | | | | Component | | (C) | |
| | | Component (A) | | | | Other | | (B) | | Mixture | |
| | | Bioresin | | | | resins | | Plasticizer | | stabilizer | |
| | | Kinds | (parts) | Kinds | (parts) | Kinds | (parts) | Kinds | (parts) | Kinds | (parts) |
| Example | 1 | CA1 | 91.5 | | | | | PL1 | 8.5 | ST1 | 0.5 |
| | 2 | CA1 | 91.5 | PE1 | 5 | PM1 | 5 | PL1 | 8.5 | ST1 | 0.5 |
| | 3 | RC2 | 100 | | | | | PL4 | 5 | ST1 | 0.5 |
| | 4 | RC1 | 100 | PE1 | 15 | | | | | ST1 | 0.5 |
| | 5 | RC2 | 100 | | | | | | | ST1 | 0.5 |
| | 6 | RC1 | 100 | | | | | | | ST1 | 0.5 |
| | 7 | CA3 | 91.5 | | | | | PL1 | 8.5 | ST1 | 0.5 |
| | 8 | CA4 | 91.5 | | | | | PL1 | 8.5 | ST1 | 0.5 |
| | 9 | CA7 | 85 | | | | | PL1 | 15 | ST1 | 0.5 |
| | 10 | CA8 | 75 | | | | | PL1 | 25 | ST1 | 0.5 |
| | 11 | | | PE1 | 90 | | | PL1 | 10 | ST1 | 0.5 |
| | 12 | | | PE1 | 70 | | | | | ST1 | 0.5 |
| | 13 | CA1 | 88 | PE1 | 5 | PM1 | 5 | PL6 | 12 | ST1 | 0.5 |
| | 14 | | | PE1 | 80 | | | | | | |
| | 15 | CA1 | 85 | PE1 | 5 | PM1 | 5 | PL1 | 15 | ST1 | 0.5 |
| | 16 | CA1 | 88 | | | | | PL1 | 12 | ST1 | 0.5 |
| | 17 | CA1 | 88 | | | | | PL4 | 12 | ST1 | 0.5 |
| | 18 | CA1 | 84 | | | | | PL1 | 16 | ST1 | 0.5 |
| | 19 | PE2 | 50 | | | PM1 | 50 | PL1 | 8.5 | | |
| | 20 | PA1 | 50 | | | PM1 | 50 | PL1 | 8.5 | | |
| | 21 | PE3 | 50 | | | PM1 | 50 | PL1 | 8.5 | | |
| Comparative | 1 | CA1 | 47.5 | CA2 | 47.5 | | | | | ST1 | 0.5 |
| Example | 2 | CA1 | 90 | | | | | | | ST1 | 0.5 |
| | 3 | CA1 | 40 | CA2 | 40 | | | PL7 | 15 | ST1 | 0.5 |
| | 4 | RC1 | 100 | — | — | — | — | — | — | — | — |
| | 5 | RC2 | 100 | — | — | — | — | — | — | — | — |

| | | | | | | Conditions | | |
|---|---|---|---|---|---|---|---|---|
| | | | | | | Kneading | Molding | Mold |
| | | Other additives | | | | temperature | temperature | temperature |
| | | Kinds | (parts) | Kinds | (parts) | (° C.) | (° C.) | (° C.) |
| Example | 1 | EL1 | 7.5 | | | 200 | 200 | 40 |
| | 2 | EL1 | 7.5 | LU1 | 2 | 200 | 200 | 40 |
| | 3 | | | | | 230 | 230 | 60 |
| | 4 | EL1 | 5 | | | 200 | 200 | 40 |
| | 5 | | | | | 200 | 200 | 40 |
| | 6 | | | | | 220 | 220 | 40 |
| | 7 | EL1 | 7.5 | | | 200 | 200 | 40 |
| | 8 | EL1 | 7.5 | | | 200 | 200 | 40 |
| | 9 | EL1 | 7.5 | | | 220 | 220 | 40 |
| | 10 | EL1 | 7.5 | | | 230 | 230 | 40 |
| | 11 | | | | | 180 | 180 | 60 |
| | 12 | EL1 | 30 | | | 170 | 170 | 60 |
| | 13 | EL1 | 10 | | | 180 | 180 | 60 |
| | 14 | EL1 | 20 | | | 180 | 180 | 60 |
| | 15 | EL1 | 7.5 | LU1 | 2 | 200 | 200 | 40 |
| | 16 | | | | | 200 | 200 | 40 |
| | 17 | | | | | 200 | 200 | 40 |
| | 18 | | | LU1 | 2 | 200 | 200 | 40 |
| | 19 | EL1 | 7.5 | | | 180 | 180 | 40 |
| | 20 | EL1 | 7.5 | | | 230 | 230 | 60 |
| | 21 | EL1 | 7.5 | | | 170 | 170 | 40 |
| Comparative | 1 | EL5 | 4.5 | | | 230 | 230 | 40 |
| Example | 2 | EL5 | 9.5 | | | 220 | 220 | 40 |
| | 3 | EL5 | 4.5 | | | 240 | 240 | 40 |
| | 4 | — | — | — | — | 200 | 200 | 40 |
| | 5 | — | — | — | — | 230 | 230 | 60 |

TABLE 2

| | | Physical property | | | | | | Evaluation | | |
|---|---|---|---|---|---|---|---|---|---|---|
| | | the | | | | | | Minimum holding | | |
| | | content of | | | | | | pressure with | | |
| | | biomass- | | | | | | mold shrinkage | | |
| | | derived | E′ f80/ | E′ f90/ | E′ f25/ | (E′ f80/E″ f80) | (E′ f25/E″ f25) | rate of 0.4% | | |
| | | carbon atom | E″ f80 | E″ f90 | E″ f25 | (E′ f90/E″ f90) | (E′ f80/E″ f80) | or less | Burr | Warpage |
| | | (%) | [80° C.] | [90° C.] | [25° C.] | [80° C.], [90° C.] | [250° C.], [80° C.] | MPa | overpack | mm |
| Example | 1 | 46.7 | 9.4 | 7.9 | 14.1 | 1.19 | 1.50 | 50.00 | None | 0.21 |
| | 2 | 47.8 | 7.3 | 5.7 | 15.2 | 1.28 | 2.08 | 40.00 | None | 0.18 |
| | 3 | 42.5 | 9.6 | 8.1 | 17.4 | 1.19 | 1.81 | 50.00 | None | 0.25 |
| | 4 | 30 | 9.9 | 8.3 | 15.6 | 1.19 | 1.58 | 50.00 | None | 0.26 |
| | 5 | 40.5 | 13.1 | 11.7 | 20.3 | 1.12 | 1.55 | 70.00 | None | 0.85 |
| | 6 | 36.5 | 6.8 | 4.4 | 17.1 | 1.55 | 2.51 | 40.00 | Burr | 0.22 |
| | | | | | | | | | (thread-like) | |
| | 7 | 50.8 | 8.1 | 6.5 | 16.0 | 1.25 | 1.98 | 50.00 | None | 0.2 |
| | 8 | 48.7 | 10.6 | 8.4 | 19.0 | 1.26 | 1.79 | 60.00 | None | 0.24 |
| | 9 | 60.3 | 14.9 | 13.1 | 23.2 | 1.14 | 1.56 | 70.00 | None | 0.98 |
| | 10 | 63.9 | 14.6 | 11.7 | 22.0 | 1.25 | 1.51 | 70.00 | None | 0.77 |
| | 11 | 99.3 | 5.9 | 4.4 | 14.7 | 1.34 | 2.49 | 40.00 | Burr | 0.15 |
| | | | | | | | | | (thread-like) | |
| | 12 | 63.7 | 5.3 | 4.7 | 25.5 | 1.13 | 4.81 | 40.00 | Burr | 0.18 |
| | | | | | | | | | (thread-like) | |
| | 13 | 34.2 | 5.5 | 4.7 | 31.1 | 1.17 | 5.65 | 40.00 | Burr | 0.21 |
| | | | | | | | | | (thread-like) | |
| | 14 | 75.4 | 6.9 | 5.9 | 22.1 | 1.17 | 3.20 | 60.00 | Burr | 0.17 |
| | | | | | | | | | (thread-like) | |
| | 15 | 52.3 | 5.1 | 2.8 | 14.7 | 1.82 | 2.88 | 40.00 | Burr | 0.16 |
| | | | | | | | | | (thread-like) | |
| | 16 | 53.6 | 8.1 | 6.3 | 13.5 | 1.29 | 1.67 | 50.00 | None | 0.2 |
| | 17 | 50.6 | 9.3 | 5.1 | 13.1 | 1.82 | 1.41 | 50.00 | Burr | 0.19 |
| | | | | | | | | | (thread-like) | |
| | 18 | 56.7 | 8.9 | 5.3 | 12.4 | 1.68 | 1.39 | 40.00 | Burr | 0.18 |
| | | | | | | | | | (thread-like) | |
| | 19 | 59.1 | 8.2 | 6.8 | 13.8 | 1.21 | 1.68 | 70.00 | None | 0.15 |
| | 20 | 55.6 | 12.8 | 10.2 | 18.2 | 1.25 | 1.42 | 60.00 | None | 0.3 |
| | 21 | 50.8 | 6.8 | 5.2 | 10.6 | 1.31 | 1.56 | 60.00 | None | 0.19 |
| Comparative | 1 | 40.7 | 18.1 | 16.4 | 30.1 | 1.10 | 1.66 | 100.00 | None | 2.1 |
| Example | 2 | 38.2 | 16.7 | 13.9 | 28.4 | 1.20 | 1.70 | 90.00 | None | 1.8 |
| | 3 | 32.7 | 3.9 | 2.5 | 12.1 | 1.56 | 3.10 | F | Burr | — |
| | | | | | | | | | (sheet-like) | |
| | 4 | 36.7 | 4.8 | 2.7 | 13.2 | 1.78 | 2.75 | F | Burr | — |
| | | | | | | | | | (sheet-like) | |
| | 5 | 39.6 | 15.2 | 12.9 | 26.1 | 1.18 | 1.72 | 90.00 | None | 2.2 |

From the above results indicated in tables, it is understood that the resin composition of example may obtain a resin molded article with high dimensional accuracy as compared with the resin composition of comparative example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A resin composition comprising:
a resin (A) having a biomass-derived carbon atom,
wherein:
a content of the resin (A) in the resin composition is 50% by weight or more with respect to the entire weight of the resin composition, and
a ratio (E′f80/E″f80) of a storage modulus E′f80 to a loss modulus E″f80 at a frequency of 1 Hz and at a temperature of 80° C. is from 5 to 15, in a dynamic viscoelasticity measurement defined in JIS K7244-3:1999.

2. The resin composition according to claim 1,
wherein a content of the biomass-derived carbon atom in the resin composition, which is defined in ASTM D6866:2012, is 30% or more with respect to a total amount of carbon atoms in the resin composition.

3. The resin composition according to claim 1,
wherein the resin (A) is at least one selected from the group consisting of a cellulose acylate and an aliphatic polyester resin.

4. The resin composition according to claim 2,
wherein the resin (A) is at least one selected from the group consisting of a cellulose acylate and an aliphatic polyester resin.

5. The resin composition according to claim 3,
wherein the resin (A) is at least one selected from the group consisting of a cellulose acetate propionate and a cellulose acetate butyrate.

6. The resin composition according to claim 4,
wherein the resin (A) is at least one selected from the group consisting of a cellulose acetate propionate and a cellulose acetate butyrate.

7. The resin composition according to claim 3,
wherein the resin (A) is a polyhydroxyalkanoate.

8. The resin composition according to claim 4,
wherein the resin (A) is a polyhydroxyalkanoate.

9. The resin composition according to claim 1, further comprising:
a plasticizer (B); and
a compound (C) that is at least one selected from the group consisting of a hindered phenol compound, a tocopherol compound, a tocotrienol compound, a phosphite compound, and a hydroxylamine compound,
wherein the resin (A) is a cellulose acylate.

10. The resin composition according to claim 2, further comprising:
a plasticizer (B); and
a compound (C) that is at least one selected from the group consisting of a hindered phenol compound, a tocopherol compound, a tocotrienol compound, a phosphite compound, and a hydroxylamine compound,
wherein the resin (A) is a cellulose acylate.

11. The resin composition according to claim 1,
wherein the ratio (E′f80/E″f80) of the storage modulus E′f80 to the loss modulus E″f80 at the frequency of 1 Hz and at the temperature of 80° C. is from 6.5 to 13, in the dynamic viscoelasticity measurement defined in JIS K7244-3:1999.

12. The resin composition according to claim 2,
wherein the ratio (E′f80/E″f80) of the storage modulus E′f80 to the loss modulus E″f80 at the frequency of 1 Hz and at the temperature of 80° C. is from 6.5 to 13, in the dynamic viscoelasticity measurement defined in JIS K7244-3:1999.

13. The resin composition according to claim 1,
wherein a ratio (E′f90/E″f90) of a storage modulus E′f90 to a loss modulus E″f90 at a frequency of 1 Hz and at a temperature of 90° C. is from 3 to 12, in the dynamic viscoelasticity measurement defined in JIS K7244-3:1999.

14. The resin composition according to claim 2,
wherein a ratio (E′f90/E″f90) of a storage modulus E′f90 to a loss modulus E″f90 at a frequency of 1 Hz and at a temperature of 90° C. is from 3 to 12, in the dynamic viscoelasticity measurement defined in JIS K7244-3:1999.

15. The resin composition according to claim 1,
wherein a value [(E′f80/E″f80)/(E′f90/E″f90)] of the ratio (E′f80/E″f80) of the storage modulus E′f80 to the loss modulus E″f80 at the frequency of 1 Hz and at the temperature of 80° C. with respect to a ratio (E′f90/E″f90) of a storage modulus E′f90 to a loss modulus E″f90 at a frequency of 1 Hz and at a temperature of 90° C. is from 1.15 to 1.35, in the dynamic viscoelasticity measurement defined in JIS K7244-3:1999.

16. The resin composition according to claim 2,
wherein a value [(E′f80/E″f80)/(E′f90/E″f90)] of the ratio (E′f80/E″f80) of the storage modulus E′f80 to the loss modulus E″f80 at the frequency of 1 Hz and at the temperature of 80° C. with respect to a ratio (E′f90/E″f90) of a storage modulus E′f90 to a loss modulus E″f90 at a frequency of 1 Hz and at a temperature of 90° C. is from 1.15 to 1.35, in the dynamic viscoelasticity measurement defined in JIS K7244-3:1999.

17. The resin composition according to claim 1,
wherein a value [(E′f25/E″f25)/(E′f80/E″f80)] of a ratio (E′f25/E″f25) of a storage modulus E′f25 to a loss modulus E″f25 at a frequency of 1 Hz and at a temperature of 25° C. with respect to the ratio (E′f80/E″f80) of the storage modulus E′f80 to the loss modulus E″f80 at the frequency of 1 Hz and at the temperature of 80° C. is from 1.4 to 3.5, in the dynamic viscoelasticity measurement defined in JIS K7244-3:1999.

18. The resin composition according to claim 2,
wherein a value [(E′f25/E″f25)/(E′f80/E″f80)] of a ratio (E′f25/E″f25) of a storage modulus E′f25 to a loss modulus E″f25 at a frequency of 1 Hz and at a temperature of 25° C. with respect to the ratio (E′f80/E″f80) of the storage modulus E′f80 to the loss modulus E″f80 at the frequency of 1 Hz and at the temperature of 80° C. is from 1.4 to 3.5, in the dynamic viscoelasticity measurement defined in JIS K7244-3:1999.

19. A resin molded article comprising the resin composition according to claim 1.

20. The resin molded article according to claim 19 that is an injection molded article.

21. The resin composition according to claim 1,
wherein the resin (A) is at least one resin selected from the group consisting of cellulose acylate, biomass-derived polyester, biomass-derived polyolefin, biomass-derived polyethylene terephthalate, biomass-derived polyamide, polytrimethylene terephthalate (PTT), polybutylene succinate (PBS), phosphatidylglycerol (PG), an isosorbide polymer, and an acrylic acid modified rosin.
